(19) United States
(12) Patent Application Publication
(10) Pub. No.: US 2018/0172879 A1
(43) Pub. Date: Jun. 21, 2018

(54) METHOD AND DEVICE FOR DETERMINING A PERMEABILITY WITHIN A RESERVOIR

(71) Applicant: STORENGY, Bois Colombes (FR)

(72) Inventor: Frédéric Huguet, Fosses (FR)

(21) Appl. No.: 15/739,453

(22) PCT Filed: Jun. 24, 2016
(86) PCT No.: PCT/FR16/51557

§ 371 Date: Dec. 22, 2017

(30) Foreign Application Priority Data
Jun. 25, 2015 (FR) 1555885

(51) Int. Cl. G01V 11/00; G06N 7/00

(52) U.S. Cl. CPC G01V 11/002; G06N 7/005

(57) ABSTRACT

The invention relates to a determination method for determining a plurality of first relationships associating permeability with porosity within an underground reservoir. The method includes an obtaining step that includes obtaining a first plurality of measurement points for the reservoir, each measurement point including a porosity data value and a first permeability data value. The method also includes a definition step that includes defining a family of relationships associating porosity with at least one permeability. The method further includes a first counting step that includes, for each relationship of the family of relationships, counting measurement points in the plurality of points reproduced by the relationship. In addition, the method includes a selection step that includes selecting a plurality of first relationships in the family based on at least a result of the counting step.

### BACKGROUND OF THE INVENTION

The invention lies in the field of exploitations of reservoirs of deposits of hydrocarbons or gas or for underground storage of compressible fluids, whether natural deposits or artificial storage.

In this field, it is useful to model the geological characteristics of a reservoir as accurately as possible in order to define the best technical and economic exploitation of the reservoir.

By way of example, FIG. 1 shows a reservoir 1 containing hydrocarbons, for example. The hydrocarbons are extracted from the reservoir by wells 2. In this example, the wells 2 correspond to cylinders that extend vertically through the reservoir 1 (it is also possible for non-vertical wells to exist).

Conventionally, the rock formation constituting the reservoir 1 is described using two complementary parameters that are porosity and permeability. Specifically porosity measures the percentage of pores in the rock that are capable of containing hydrocarbons, whereas permeability describes the capacity of the rock to allow fluids to pass horizontally (horizontal permeability Kh) or vertically (vertical permeability Kv), with it also being possible for this capacity to be calculated over the full height of the reservoir (total horizontal permeability or total vertical permeability). These two parameters (permeability and porosity) are thus characteristic of the exploitation performance of a reservoir.

It is known that the porosity φ and the permeability K along a well 2 can be measured by analyzing cores taken from the reservoir-rock, e.g. while drilling the well. A set of discrete porosity and permeability measurements is thus obtained for each well 2.

The capacity to take a measurement on a sample core depends on its consolidation or cementation. In certain reservoirs, levels of low consolidation, corresponding to the greatest permeabilities, cannot be sampled, thereby introducing bias in the representativity of the measurements.

It will readily be understood that the number of wells implemented for a reservoir is limited. In addition, the number of porosity and permeability measurements made along a well in its depth direction is also limited.

That said, in order to be able to use exploitation models or in order to be able to work the reservoir, it is still necessary to have information available about the porosity and the permeability at all points in the reservoir.

Given that measuring permeability is a complicated process, proposals have been made to determine a relationship associating the porosity φ to the permeability K within a reservoir. Such a relationship is generally referred to as a φ-K relationship.

Generally, a φ-K relationship is determined by regression performed on a set of porosity and permeability measurements taken for a set of wells.

That solution is not satisfactory since it is not sufficiently representative of the physical reality of the reservoir.

There therefore exists a need for a simple and effective solution that enables the distribution of permeability within an underground reservoir to be estimated better from a set of porosity and permeability measurements taken within the reservoir.

### OBJECT AND SUMMARY OF THE INVENTION

Consequently, in a first aspect, the present invention provides a determination method for determining a plurality of first relationships associating permeability with porosity within an underground reservoir, e.g. in order to estimate permeability distribution within an underground reservoir, in particular on the basis of a set of porosity and permeability measurements taken within the reservoir. The method comprises:
an obtaining step for obtaining a first plurality of measurement points for the reservoir, each measurement point comprising a porosity data value and a first permeability data value;
a definition step for defining a family of relationships associating porosity with at least one permeability (φ-K relationship);
a first counting step for each relationship of the family, for counting measurement points in the plurality of points reproduced by the relationship; and
a selection step for selecting a plurality of first relationships in the family on the basis of at least the result of the counting step, e.g. in order to deduce therefrom a distribution of the permeability within the reservoir.

The method may be performed by a computer system.

The invention thus proposes representing the permeability distribution within an underground reservoir by a set of φ-K relationships representing in simple manner the relationship between permeability and porosity within the reservoir, the relationships in this set being selected, by way of example, as being those relationships for which the result of the counting step exceeds a threshold.

Unlike the solutions in the prior art in which a single φ-K relationship is selected, a plurality of φ-K relationships are obtained that are considered to be properly representative of the reservoir, thus making it possible to estimate the permeability within the reservoir as accurately as possible.

More precisely, the determination method is based on analyzing the ability of a family of φ-K relationships to reproduce a set of porosity and permeability measurements.

The set of measurements may be obtained at the scale of the reservoir, or from a subset of the wells of the reservoir, or indeed from a single well. At reservoir scale, a family of φ-K relationships is obtained for the entire reservoir, whereas with a single well the family of φ-K relationships is representative only of the relationship between porosity and permeability at the scale of a single well. By way of example, it is up to a geologist to segment the reservoir into subsets of wells having the same characteristics in order to calculate different φ-K relationships for each of those subsets.

In the meaning of the invention, a measurement is reproduced by a φ-K relationship when the distance between the point representing the measurement and the curve representing the φ-K relationship is below a threshold, this distance being evaluated in the (φ, K) space or in a space derived therefrom after changing a variable.

By way of example, the threshold may be selected beforehand as a function of the application and of the numbers of φ-K relationships that it is desired to obtain for representing the permeability distribution within the reservoir in more representative manner.

In a particular implementation of the invention, said selected plurality of relationships is selected from the relationships of the family that reproduce at least some minimum number of measurement points of the plurality of measurement points.

In other words, after being normalized relative to one, the function allocating the result of counting the measurement points that are reproduced by the relationship to each of the relationships of the family of relationships is interpreted as a probability distribution.

By setting a cumulative probability threshold, corresponding to a (normalized) number of measurement points that are reproduced, it is possible to define a set of φ-K relationships that represent the most probable pertinent relationships.

In particular, it is possible to select the relationship that is the most representative by selecting a relationship corresponding at least to a maximum of the result of the counting.

In a particular implementation, a counting result is weighted so as to be greater if the measurement points reproduced by the relationship are distributed along the vicinity of the curve representing the relationship. For selection purposes, this makes it possible to give preference to relationships that are corroborated by measurement points over a wider range of values. For example, the result of the counting may be weighted in a manner that is proportional to the product of the variances of the components of the plurality of transformed points.

In a particular implementation, the relationships associating porosity to permeability are determined by at least two parameters.

In a particular implementation of the invention, the relationships of the family of relationships are semi-log relationships or log-log relationships.

Specifically, the inventors have observed that, to a first approximation, the logarithm (base 10) of the permeability is generally correlated either to the porosity φ (semi-log relationship) or else to the logarithm (base 10) of the porosity (log-log relationship). The semi-log or log-log form of the φ-K relationship depends on the intrinsic nature of the rock constituting the reservoir, and the person skilled in the art knows how to select the appropriate form as a function of the rock.

On the basis of this observation, a φ-K relationship may be defined by two parameters A, B for a semi-log relationship defined by log(K)=A·φ+B or for a log-log relationship defined by log(K)=A·log(φ)+B.

It should be observed that polynomial relationships of higher order may also be considered between the variables (log(K), φ) or (log(K), log(φ)).

In a particular implementation of the invention, the relationships of the family of relationships are semi-log relationships defined by two parameters A and B and the counting step comprises:
a transformation step for transforming the plurality of measurement points by applying the logarithm function to the first permeability data; and a representation step for representing the plurality of transformed points in the form of an intensity image;
the counting comprising counting the number of points in the plurality of transformed points represented in the intensity image that are at a distance from a straight line having the equation Y=A·X+B is below a threshold, e.g. as estimated from the resolution of the intensity image.

Thus, with a semi-log model, the change of variable performed by applying the logarithm function to the permeability data makes it possible to obtain a representation space for the measurement points in which the semi-log models are represented by straight lines of equation Y=A·X+B.

In this representation space, the cloud of (φᵢ, log(Kᵢ)) points is represented in the form of an intensity image, the value of each of the points in the image being proportional to the number of observed (φᵢ, log(Kᵢ)) data values.

It should be observed that in this (φᵢ, log(Kᵢ)) space, the number of measurement points in the plurality of measurement points that are reproduced by a semi-log relationship log(K)=A·φ+B is counted merely by counting the number of points lying at a distance from the straight line having the equation Y=A·X+B that is less than a threshold, e.g. as estimated from the resolution of the intensity image.

In the space of the parameters A and B, the selected plurality of φ-K relationships is represented by a set of Aᵢ, Bᵢ pairs for which the count exceeds a threshold.

The count corresponds substantially to integrating this distance for these points along the straight line in question, with each point having the same weight, which operation is intellectually similar to the curvilinear integrals of the Radon transform used in other fields.

In a particular implementation of the invention, the relationships of the family of relationships are log-log relationships defined by two parameters A and B, and the counting step comprises:
a transformation step for transforming the plurality of measurement points by applying the logarithm function to the first permeability data values and to the porosity data values; and
a representation step for representing the plurality of transformed points in the form of an intensity image;

the counting comprising counting the number of points in the plurality of transformed points represented in the intensity image that are at a distance that is below a threshold from a straight line having the equation Y=A·X+B.

Thus, for a log-log model, the change of variable performed by applying the logarithm function to the permeability data and to the porosity data makes it possible to obtain a representation space for the measurement points in which log-log models are represented by straight lines of equation Y=A·X+B.

In this representation space, the number of measurement points in the plurality of points that are reproduced by a log-log relationship log(K)=A·log(φ)+B is counted merely by counting the number of points that are at a distance from the straight line having the equation Y=A·X+B that is below a threshold, e.g. as estimated from the resolution of the intensity image.

In a particular implementation of the invention, the method of the invention further comprises a smoothing step of smoothing the intensity image prior to the counting.

Smoothing the intensity image makes it possible to limit excessive disparities between neighboring pixels as generated by the uncertainty on the measurements of porosity data and permeability data.

In a particular implementation of the invention, the porosity data and the first permeability data is obtained by analyzing sample cores from the reservoir or by analyzing logging measurements, and the obtaining step further comprises an addition step for adding additional measurement points to the first plurality of points, the added additional measurement points being selected from the first plurality of measurement points on the basis of analyzing second permeability data obtained from at least one formation test performed within the reservoir.

In the meaning of the invention, an additional measurement point is thus a measurement point that is extracted from the (φᵢ, Kᵢ) data and that is subsequently added to the same (φᵢ, Kᵢ) measurements in order to determine the plurality of first relationships associating porosity with permeability.

The ability to make a measurement on a sample core depends on its consolidation or cementation. In certain reservoirs having low consolidation levels, corresponding to the highest permeabilities, these levels cannot be sampled, thereby leading to bias in the representativity of the measurements.

Thus, and in particularly advantageous manner, the invention makes it possible to correct this bias by improving the representation of the distribution of permeability within an underground reservoir by aggregating permeability data coming from various origins. In particular, when formation tests of the drill stem testing (DST) type are available, the associated measurements integrating permeability over a significant depth of the reservoir are taken into account for determining the φ-K relationships.

It should be observed that formation tests make it possible to obtain horizontal permeability data and vertical permeability data, with vertical permeability data being obtained by tests of the modular dynamic tester (MDT) type or by using measurements of the repeat formation tester (RFT) type.

In a particular implementation of the invention, the addition step further comprises:
an obtaining step for obtaining a real histogram of the logarithms of the first permeability data values (i.e. a discrete distribution obtained by quantifying the distribution of the logarithms of the first porosity data values) obtained by analyzing cores or by analyzing logging measurements;
an obtaining step for obtaining a theoretical histogram of the logarithms of the second permeability data values obtained from said at least one formation test, the intervals of the theoretical histogram being equal to the intervals of the real histogram;
an obtaining step for obtaining an aggregated probability histogram obtained by calculating the product between the theoretical and real histograms; and
an obtaining step, for at least one permeability interval in which the aggregated histogram is not zero, for obtaining a set of additional measurement points, the number of additional measurement points of the set being a function of the value of the aggregated histogram evaluated for said at least one permeability interval, the additional measurement points being selected randomly from among the measurement points of the plurality for which the first permeability data value corresponds to said at least one permeability interval.

Since the permeability measurements obtained on the basis of formation tests are averaged measurements over a significant depth of the reservoir, only a small number of these porosity measurements is generally obtained.

Consequently, the determination method of the invention begins by determining a theoretical histogram for the logarithm of permeability as measured by the formation tests, referred to as the histogram of permeabilities of the tests, and based on the uncertainties relating to interpreting the tests. More precisely, the histogram of the permeabilities of the tests is a discrete distribution obtained by quantifying the distribution of the logarithms of the permeability as measured by the formation tests.

Furthermore, depending on the methods used for measuring permeability, the scale of the description of the characteristics of the reservoir-rock varies in substantial manner.

In order to give precedence to permeability data obtained by formation tests that are corroborated by permeability data obtained by other measurement methods, the determination method determines the probability that a permeability derived from formation tests corresponds to a permeability derived from some other method. The probability corresponds to the product of the theoretical histogram of the test permeabilities multiplied by the histogram of the logarithm of the permeabilities obtained from permeability measurements obtained from analyzing cores or from logging.

Thereafter, the determination method selects additional measurement points randomly from the set of existing measurement points (φᵢ, Kᵢ) for which the permeability obtained from the formation tests corresponds to the permeability Kᵢ. By way of example, this random selection is performed by means of a random draw using a uniform probability relationship.

These additional measurement points are then added to the measurement points (φᵢ, Kᵢ), thereby improving the representation of the corresponding permeability distribution.

In a particular implementation of the invention, the first permeability data value and the second permeability data value are horizontal permeabilities.

In another particular implementation of the invention, the first permeability data value and the second permeability data value are vertical permeabilities.

In other words, the determination method of the invention is independent of the anisotropic nature of the permeability of the reservoir.

In the description below, pairs of values defining a φ-K relationship associating porosity with a horizontal permeability are written (Aᵢ, Bᵢ) and pairs of values defining a φ-K relationship associating porosity with a vertical permeability are written (Avᵢ, Bvᵢ).

In a particular implementation of the invention, the family of relationships is determined by a plurality of parameters, the permeability is horizontal permeability, and the method further comprises:
an obtaining step for obtaining a second plurality of measurement points, each of the measurement points comprising one of the porosity data values and a third data value for vertical permeability;
a second counting step, for each relationship of the family, for counting points of the second plurality of points that are reproduced by the relationship;
a representation step for representing the results of the first and second counting steps in the form of first and second intensity signals depending on the plurality of parameters;
an estimation step for estimating a translation vector by analyzing a correlation between the first and second intensity signals; and
a shift step for shifting the second intensity signal by the translation vector;

said selection step taking account at least of the analysis of the first intensity signal and of the second intensity signal, said method further comprising determining a plurality of second relationships associating vertical permeability with porosity, said plurality of second relationships being obtained from said plurality of first relationships by shifting the parameters by the translation vector.

In another particular implementation of the invention, the family of relationships is determined by a plurality of parameters and the method further comprises:
an obtaining step for obtaining a second plurality of measurement points, each of the measurement points comprising one of the porosity data values and a third data value for horizontal permeability;
a second counting step, for each relationship of the family, for counting points of the second plurality of points that are reproduced by the relationship;
a representation step for representing the results of the first and second counting steps in the form of first and second intensity signals depending on the plurality of parameters;
an estimation step for estimating a translation vector by analyzing a correlation between the first and second intensity signals; and
a shift step for shifting the second intensity signal by said translation vector;

said selection step taking account at least of the analysis of the first intensity signal and of the second intensity signal, said method further comprising determining a plurality of second relationships associating horizontal permeability with porosity, the plurality of second relationships being obtained from the plurality of first relationships by shifting the parameters by the vector.

The invention thus makes it possible to take account of all of the horizontal and vertical permeability data in the method of determining φ-K relationships when such data is available.

In this way, it is possible to represent simultaneously the horizontal permeability distribution and the vertical permeability distribution within an underground reservoir by a translation vector and by a single set of φ-K relationships.

Specifically, the inventors have observed that the φ-K relationships that reproduce the greatest number of vertical permeability measurements can be deduced, to a first approximation, merely by shifting the parameters of the φ-K relationships that reproduce the greatest number of horizontal permeability measurements.

Thus, and in particularly advantageous manner, the invention makes it possible to improve the representativity of the φ-K relationships that are selected by taking account of the correlation that exists between the results of the first and second counting steps.

In another particular implementation of the invention, the method further comprises a normalization step for normalizing the first and second intensity signals prior to the estimation step for estimating said translation vector.

In a particular implementation, the various steps of the determination method are determined by computer program instructions.

Consequently, the invention also provides a computer program on a data medium, the program being suitable for being performed in a computer, the program including instructions adapted to performing steps of a determination method as described above.

The program may use any programming language, and be in the form of source codes, object codes, or codes intermediate between source code and object code, such as in a partially compiled form, or in any other desirable form.

The invention also provides a computer-readable data medium including instructions of a computer program as mentioned above.

The data medium may be any entity or device capable of storing the program. For example, the medium may comprise storage means such as a read only memory (ROM), a random access memory (RAM), a programmable read only memory (PROM), an electrically programmable read only memory (EPROM), a compact disk (CD) ROM, or indeed magnetic recording means, e.g. a floppy disk or a hard disk.

Furthermore, the data medium may be a transmissible medium such as an electrical or optical signal that is conveyed by an electrical or optical cable, by radio, or by other means. The program of the invention may in particular be downloaded from an Internet type network.

Alternatively, the data medium may be an integrated circuit in which the program is incorporated, the circuit being adapted to execute or to be used in the execution of the method in question.

The invention also provides a determination device for determining a plurality of first relationships associating permeability with porosity within an underground reservoir, e.g. a device configured to estimate the permeability distribution within an underground reservoir, in particular from a set of measurements of porosity and of permeability taken within the reservoir. The device comprises:
an obtaining module for obtaining a first plurality of measurement points for the reservoir, each measurement point comprising a porosity data value and a first permeability data value;
a definition module for defining a family of relationships associating porosity with at least one permeability;
a first counting module, for each relationship of the family of relationships, for counting measurement points of the plurality of points that are reproduced by the relationship; and
a selection module for selecting a plurality of first relationships in the family on the basis of at least the result of the counting performed by the first counting module, the device being configured, by way of example, to deduce therefrom a permeability distribution within the reservoir.

The determination device is configured to perform the determination method as defined above.

In another aspect, the present invention provides a method of estimating at least one mean permeability for a set of wells in an underground reservoir. The method comprises:
an obtaining step for obtaining a porosity data distribution for the set of wells;
an obtaining step for obtaining a plurality of first relationships associating porosity with permeability for the set by using a determination method of the invention;
an obtaining step for obtaining a probability relationship approximating the porosity data distribution on the basis of at least said plurality of first relationships; and an estimation step for estimating at least one mean permeability for the set of wells from at least the asymmetric normal relationship and said plurality of first relationships.

The inventors have observed that the experimental distribution of porosity data within a reservoir can be reproduced correctly by a probability relationship. It may be observed that a probability relationship is generally advantageously defined by a small number of parameters, e.g. two parameters for a normal relationship and three parameters for an asymmetric normal relationship.

The invention thus proposes representing a porosity distribution of a set of wells of an underground reservoir by a probability relationship.

When the expression for the probability relationship involves only a limited number of parameters, these parameters enable the porosity distribution of all of the wells to be represented effectively in full.

Furthermore, the permeability distribution in this set of wells is associated with the corresponding porosity distribution by a set of φ-K relationships that have been determined beforehand.

Consequently, the rock formation constituting the reservoir is described for a set of wells by a porosity distribution modeled by a probability relationship and by a permeability distribution modeled by a set of φ-K relationships.

Naturally, the invention also makes it possible to model a porosity distribution for a set of wells or for only one well, depending on the scale desired for analysis.

In a particular implementation of the invention, the obtaining step for obtaining a probability relationship is performed by minimizing a target function taking account of at least one term from among the following three terms:
a first term favoring probability relationships best approximating the porosity data distribution;
a second term favoring probability relationships of mean value best approximating the mean value of the porosity data distribution; and
a third term favoring probability relationships that, for each relationship selected from the first plurality of relationships, minimize the sum of the differences between the mean probability value calculated after applying the selected relationship to the porosity data distribution and the mean permeability value calculated after applying the selected relationship to the probability relationship.

Thus, the porosity distribution is represented by a probability relationship that best reproduces simultaneously the porosity distribution and the mean of the porosity and permeability distributions.

More particularly, and in a particular implementation of the invention, said plurality of first relationships is defined by the relationship log(Kh)=(Aᵢ·f(ϕ)+Bᵢ) where Kh is a horizontal permeability, Aᵢ and Bᵢ are two real parameters belonging to a determined region of space defined by the parameters A, B and where f is the identity function or the log function; and
the target function is a linear combination αE₁+(1−α)[(1−β)E₃+βE₂], where α and β are two positive coefficients and less than one, and where:
   the first term E1 is equal to

$${\sum }_{i = 1}^{n} {( {F}_{i} - LP ( {φ}_{i} , {S}_{1} , … , {S}_{g} ) )}^{2} ;$$

the second term E2 is equal to

(ϕ̅ᵢ̅−L̅P̅(S₁, . . . ,S_{g}))²; and
the third term E3 is equal to

$${\sum }_{i = 1}^{N} {( \overline{K} h ( {A}_{i} , {B}_{i} ) - \overline{K} h ( {A}_{i} , {B}_{i} , m , {S}_{1} , … , {S}_{g} ) )}^{2} with$$

$$log ( {Kh}_{j} ( {A}_{i} , {B}_{i} , {φ}_{j} ) ) = ( {A}_{i} \cdot f ( {φ}_{j} ) + {B}_{i} ) and$$

$$\overline{K} h ( {A}_{i} , {B}_{i} ) = {\sum }_{j = 1}^{n} {Kh}_{j} ( {A}_{i} , {B}_{i} , {φ}_{j} ) \cdot {F}_{j}$$

and where:
   N is the cardinal number of said determined region of the space defined by the parameters A, B;
   n is the number of intervals of the porosity data distribution;
   Fᵢ is the occurrence frequency associated with each of the intervals of porosity φᵢ;
   φ̅ᵢ̅ is the value associated with said porosity intervals; and
   K̅h̅(Aᵢ, Bᵢ, S₁, . . . , S_{g}) is the mean horizontal permeability calculated after applying the relationship log(Kh)=(Aᵢ·f(φ)+Bᵢ) to the probability relationship LP(φ; Sᵢ, . . . , S_{g}) depending on the parameters S₁, . . . , S_{g}; and
said at least one mean permeability is a horizontal mean permeability K̅h̅_̅{̅S̅}̅ given by the formula:

$$\overline{{Kh}_{S}} ( {A}_{i} , {B}_{i} ) = {\sum }_{j = 1}^{n} exp ( {A}_{i} \cdot f ( {φ}_{j} ) + {B}_{i} ) \cdot {LP}_{S} ( {φ}_{j} ; {S}_{1} , … , {S}_{g} ) ,$$

where LP_{S} is the probability relationship minimizing the target function.

In another particular implementation of the invention, said plurality of first relationships is defined by the relationship log(Kv)=(Avᵢ.f(ϕ)+Bvᵢ) where Kv is a vertical permeability, Avᵢ and Bvᵢ are two real parameters belonging to a determined region of space defined by the parameters Av, By and where f is the identity function or the log function; and
the target function is a linear combination αE₁+(1−α)[(1−β)E₃+βE₂], where α and β are two positive coefficients and less than one, and where:
   the first term E1 is equal to

$${\sum }_{i = 1}^{n} {( {F}_{i} - LP ( {φ}_{i} , {S}_{1} , … , {S}_{g} ) )}^{2} ;$$

the second term E2 is equal to

(ϕ̅ᵢ̅−L̅P̅(S₁, . . . ,S_{g}))²; and
the third term E3 is equal to

$${\sum }_{i = 1}^{N} {( \overline{K} v ( {Av}_{i} , {Bv}_{i} ) - \overline{K} v ( {Av}_{i} , {Bv}_{i} , m , {S}_{1} , … , {S}_{g} ) )}^{2} with$$

$$log ( {Kv}_{j} ( {Av}_{i} , {Bv}_{i} , {φ}_{j} ) ) = ( {A}_{i} \cdot f ( {φ}_{j} ) + {B}_{i} ) and$$

$$1 / \overline{Kv} ( {Av}_{i} , {Bv}_{i} ) = {\sum }_{j = 1}^{n} {F}_{j} / {Kv}_{j} ( {Av}_{i} , {Bv}_{i} , {φ}_{j} )$$

and where:
   N is the cardinal number of the determined region of the space defined by the parameters A, B;
   n is the number of intervals of the porosity data distribution;
   Fᵢ is the occurrence frequency associated with each of the intervals of porosity φᵢ;
   φ̅ᵢ̅ is the value associated with said porosity intervals; and
   K̅v̅(Avᵢ, Bvᵢ, S₁, . . . , S_{g}) is the mean vertical permeability calculated after applying the relationship log(Kv)=(Avᵢ·f(ϕ)+Bvᵢ) to the probability relationship LP(φ; S₁, . . . , S_{g}) depending on the parameters S₁, . . . , S_{g}; and
said at least one mean permeability is a vertical mean permeability K̅v̅_̅{̅S̅}̅ given by the formula:

$$1 / \overline{{Kv}_{S}} ( {Av}_{i} , {Bv}_{i} ) = {\sum }_{j = 1}^{n} {LP}_{S} ( {φ}_{j} ; {S}_{1} , … , {S}_{g} ) / exp ( {Av}_{i} \cdot f ( {φ}_{j} ) + {Bv}_{i} ) ,$$

where LP_{S} is the probability relationship minimizing the target function.

In a particular implementation of the invention, the method further comprises an obtaining step for obtaining a plurality of third relationships associating porosity to vertical permeability on the basis of at least the result of the second counting step, and in which:
the plurality of first relationships associates porosity with horizontal permeability; and
the obtaining step for obtaining a normal probability relationship is performed by minimizing a target function taking account of at least one term among the three following terms:
   a first term favoring probability relationships best approximating the porosity data distribution;
   a second term favoring probability relationships of mean value best approximating the mean value of the porosity data distribution; and
   a third term favoring probability relationships that, for each relationship selected from the first plurality of relationships and for each relationship selected from the third plurality of relationships, minimizes the sum of the differences between the value of the total horizontal mean permeability calculated after application of the selected relationships to the porosity data distribution and the value of the total horizontal mean permeability calculated after applying the selected relationship to the probability relationship; and
the at least one mean permeability is a total horizontal mean permeability.

Thus, the estimation method also makes it possible to estimate the horizontal total mean permeability by appropriately defining the target function that is to be minimized in order to obtain the probability relationship representing the porosity distribution.

In a particular implementation of the invention, the plurality of first relationships is defined by the relationship log(Kh)=(Aᵢ·f(ϕ)+Bᵢ) where Kh is a horizontal permeability, Aᵢ and Bᵢ are two real parameters belonging to a determined region of space defined by the parameters A, B and where f is the identity function or the log function;
the plurality of third relationships is defined by the relationship log(Kv)=(Avₘ·f(φ)+Bvₘ) where Kv is a vertical permeability, Avₘ and Bvₘ are two real parameters belonging to a determined region of space defined by the parameters Av and Bv; and
the target function is a linear combination αE₁+(1−α)[(1−β)E₃+βE₂], where α and β are two positive coefficients and less than one, and where:
   the first term E1 is equal to

$${\sum }_{i = 1}^{n} {( {F}_{i} - LP ( {φ}_{i} , {S}_{1} , … , {S}_{g} ) )}^{2} ;$$

the second term E2 is equal to

(ϕ̅ᵢ̅−L̅P̅(S₁, . . . ,S_{g}))²; and
the third term E3 is equal to

$${\sum }_{m = 1}^{M} {\sum }_{i = 1}^{N} {( \overline{K} ht ( {A}_{i} , {B}_{i} , {Av}_{m} , {Bv}_{m} ) - \overline{Kht} ( {A}_{i} , {B}_{i} , {Av}_{m} , {Bv}_{m} , {S}_{1} , … , {S}_{g} ) )}^{2}$$

$$with \overline{Kht} ( {A}_{i} , {B}_{i} , {Av}_{m} , {Bv}_{m} ) = {C}_{h} \cdot \overline{Kh} ( {A}_{i} , {B}_{i} ) + ( 1 - {C}_{h} ) \cdot \overline{Kv} ( {Av}_{m} , {Bv}_{m} ) ;$$

$$log ( {Kv}_{j} ( {Av}_{m} , {Bv}_{m} , {φ}_{j} ) ) = ( {Av}_{m} \cdot f ( {φ}_{j} ) + {Bv}_{m} ) ;$$

$$1 / \overline{Kv} ( {Av}_{m} , {Bv}_{m} ) = {\sum }_{j = 1}^{n} {F}_{j} / {Kv}_{j} ( {Av}_{m} , {Bv}_{m} , {φ}_{j} ) ;$$

$$log ( {Kh}_{j} ( {A}_{i} , {B}_{i} , {φ}_{j} ) ) = ( {A}_{i} \cdot f ( {φ}_{j} ) + {B}_{i} ) ;$$

$$\overline{K} h ( {A}_{i} , {B}_{j} ) = {\sum }_{j = 1}^{n} {F}_{j} \cdot {Kh}_{j} ( {A}_{i} , {B}_{i} , {φ}_{j} )$$

and where:
   Cₕ is a positive coefficient lying in the range 0 to 1;
   N is the cardinal number of the determined region of the space defined by the parameters A, B;
   M is the cardinal number of the determined region of the space defined by the parameters Av, Bv;
   n is the number of intervals of the porosity data distribution;
   Fᵢ is the occurrence frequency associated with each of the intervals of porosity ϕᵢ;
   φ̅ᵢ̅ is the value associated with said porosity intervals; and
   K̅h̅t̅(Aᵢ, Bᵢ, Avₘ, Bvₘ, S₁, . . . , S_{g}) is the horizontal mean permeability calculated after applying the relationships log(Kh)=(Aᵢ·f(ϕ)+Bᵢ) and log(Kv)=(Avₘ·f(ϕ)+Bvₘ) to the probability relationship LP(φ; S₁, . . . , S_{g}) depending on the parameters S₁, . . . , S_{g}; and
said at least one mean permeability is a total horizontal mean permeability given by one of the formulas:

$$\overline{{Kht}_{S}} ( {A}_{i} , {B}_{i} , {Av}_{m} , {Bv}_{m} ) = {\sum }_{j = 1}^{n} {Kht}_{j} ( {A}_{i} , {B}_{i} , {Av}_{m} , {Bv}_{m} , {φ}_{j} ) \cdot {LP}_{S} ( {φ}_{j} ; {S}_{1} , … , {S}_{g} ) ;$$

where LP_{S} is the probability relationship minimizing the target function.

In a particular implementation of the invention, the method further comprises an obtaining step for obtaining a plurality of third relationships associating porosity with vertical permeability on the basis of at least the result of the second counting step, and wherein:
the plurality of first relationships associates porosity with horizontal permeability; and
the obtaining step for obtaining a normal probability relationship is performed by minimizing a target function taking account of at least one term selected from the three following terms:
   a first term favoring probability relationships best approximating the porosity data distribution;
   a second term favoring probability relationships of mean value best approximating the mean value of the porosity data distribution; and
   a third term favoring probability relationships that, for each relationship selected from the first plurality of relationships and for each relationship selected from the plurality of third relationships, minimizes the sum of the differences between the value of the total vertical mean permeability calculated after applying the selected relationships to the porosity data distribution and the total vertical mean permeability calculated after applying the relationship selected to the probability relationship; and
said at least one mean permeability is a total vertical mean permeability.
   In a particular implementation of the invention, the plurality of first relationships is defined by the relationship log(Kh)=(Aᵢ·f(ϕ)+Bᵢ) where Kₕ is a horizontal permeability, Ai and Bi are two real parameters belonging to a determined region of space defined by the parameters A, B and where f is the identity function or the log function;
the plurality of third relationships is defined by the relationship log(Kv)=(Avₘ·f(ϕ)+Bvₘ) where Kᵥ is a vertical permeability, Avₘ and Bvₘ are two real parameters belonging to a determined region of space defined by the parameters Av and Bv; and
the target function is a linear combination αEᵢ+(1−α)[(1−β)E₃+βE₂], where α and β are two positive coefficients and less than one, and where:
   the first term E1 is equal to

$${\sum }_{i = 1}^{n} {( {F}_{i} - LP ( {φ}_{i} , {S}_{1} , … , {S}_{g} ) )}^{2} ;$$

the second term E2 is equal to

(ϕ̅ᵢ̅−L̅P̅(S₁, . . . ,S_{g}))²; and
the third term E3 is equal to

$${\sum }_{m = 1}^{M} {\sum }_{i = 1}^{N} {( \overline{K} vt ( {A}_{i} , {B}_{i} , {Av}_{m} , {Bv}_{m} ) - \overline{Kvt} ( {A}_{i} , {B}_{i} , {Av}_{m} , {Bv}_{m} , {S}_{1} , … , {S}_{g} ) )}^{2}$$

$$with$$

$$\overline{Kvt} ( {A}_{i} , {B}_{i} , {Av}_{m} , {Bv}_{m} ) = {C}_{v} \cdot \overline{Kh} ( {A}_{i} , {B}_{i} ) + ( 1 - {C}_{v} ) \cdot \overline{Kv} ( {Av}_{m} , {Bv}_{m} ) ;$$

$$log ( {Kv}_{j} ( {Av}_{m} , {Bv}_{m} , {φ}_{j} ) ) = ( {Av}_{m} \cdot f ( {φ}_{j} ) + {Bv}_{m} ) ;$$

$$1 / \overline{Kv} ( {Av}_{m} , {Bv}_{m} ) = {\sum }_{j = 1}^{n} {F}_{j} / {Kv}_{j} ( {Av}_{m} , {Bv}_{m} , {φ}_{j} ) ;$$

$$log ( {Kh}_{j} ( {A}_{i} , {B}_{i} , {φ}_{j} ) ) = ( {A}_{i} \cdot f ( {φ}_{j} ) + {B}_{i} ) ;$$

$$\overline{K} h ( {A}_{i} , {B}_{i} ) = {\sum }_{j = 1}^{n} {F}_{j} \cdot {Kh}_{j} ( {A}_{i} , {B}_{i} , {φ}_{j} )$$

and where:
   Cᵥ is a positive coefficient lying in the range 0 to 1;
   N is the cardinal number of said determined region of the space defined by the parameters A, B;
   M is the cardinal number of said determined region of the space defined by the parameters Av, Bv;
   n is the number of intervals of said porosity data distribution;
   Fᵢ is the occurrence frequency associated with each of the intervals of porosity ϕᵢ;
   φ̅ᵢ̅ is the value associated with said porosity intervals; and
   K̅v̅t̅(Aᵢ, Bᵢ, Avₘ, Bvₘ, S₁, . . . , S_{g}) is the vertical mean permeability calculated after applying the relationships log(Kh)=(Aᵢ·f(ϕ)+Bᵢ) and log(Kv)=(Avₘ·f(ϕ)+Bvᵢₘ) to the probability relationship LP(φ; S₁, . . . , S_{g}) depending on the parameters S₁, . . . , S_{g}; and
said at least one mean permeability is a total vertical mean permeability given by one of the formulas:

$$\overline{1 / {Kvt}_{S}} ( {A}_{i} , {B}_{i} , {Av}_{m} , {Bv}_{m} ) = {\sum }_{j = 1}^{n} 1 / {Kvt}_{j} ( {A}_{i} , {B}_{i} , {Av}_{m} , {Bv}_{m} , {φ}_{j} ) \cdot {LP}_{S} ( {φ}_{j} ; {S}_{1} , … , {S}_{g} ) ;$$

where LP_{S} is the probability relationship minimizing the target function.

In a particular implementation of the invention, the obtaining step for obtaining a probability relationship is performed on the basis of at least said plurality of second relationships, the method further comprising an estimation step for estimating at least one total vertical mean permeability on the basis of at least the probability relationship and of said plurality of second relationships.

In other words, in this particular implementation of the invention, the estimation method makes it possible simultaneously to estimate the horizontal total mean permeability and the vertical total mean permeability.

This joint estimation of the horizontal total mean permeability and of the vertical total mean permeability makes it necessary to define appropriately the target function that is to be minimized in order to obtain the probability relationship that represents the porosity distribution.

Thus, in a particular implementation of the invention, the obtaining step for obtaining a probability relationship is performed by minimizing a target function taking account of at least one term from among the following three terms:
a first term favoring probability relationships best approximating the porosity data distribution;
a second term favoring probability relationships of mean value best approximating the mean value of the porosity data distribution; and
a third term favoring probability relationships that, for each selected relationship, minimize said first plurality of relationships:
   the sum of the differences between the value of the total horizontal mean permeability calculated after applying the selected relationship to said porosity data distribution and the value of the total horizontal mean permeability calculated after applying the selected relationship to the probability relationship; and
   the sum of the differences between the value of the total vertical mean permeability calculated after applying the selected relationship to the porosity data distribution and the value of the total vertical mean permeability calculated after applying the selected relationship to the probability relationship.

In a particular implementation of the invention, the plurality of first relationships is defined by the relationship log(K_{H})=(Aᵢ·f(ϕ)+Bᵢ) where Kh is a horizontal permeability, Aᵢ and Bᵢ are two real parameters belonging to a determined region of space defined by the parameters A, B and where f is the identity function or the log function;
the plurality of second relationships is defined by the relationship log(K_{V})=((Aᵢ+dA)·f(ϕ)+Bᵢ+dB) where Kv is a vertical permeability and dA and dB are two real parameters; and
the target function is a linear combination αE₁+(1−α)[(1−β)E₃+βE₂], where α and β are two positive coefficients and less than one, and where:
   the first term E1 is equal to

$${\sum }_{i = 1}^{n} {( {F}_{i} - LP ( {φ}_{i} , {S}_{1} , … , {S}_{g} ) )}^{2} ;$$

the second term E2 is equal to

(ϕ̅ᵢ̅−L̅P̅(S₁, . . . ,S_{g}))²; and
the third term E3 is equal to

$${\sum }_{i = 1}^{N} {( \overline{Kht} ( {A}_{i} , {B}_{i} ) - \overline{Kht} ( {A}_{i} , {B}_{i} , m , {S}_{1} , {S}_{1} / {S}_{2} ) )}^{2} + {( \overline{Kv} t ( {A}_{i} , {B}_{i} ) - \overline{Kvt} ( {A}_{i} , {B}_{i} , m , {S}_{1} , {S}_{1} / {S}_{2} ) )}^{2}$$

$$with$$

$$\overline{Kht} ( {A}_{i} , {B}_{i} ) = {C}_{h} \cdot \overline{Kh} ( {A}_{i} , {B}_{i} ) + ( 1 - {C}_{h} ) \cdot \overline{Kv} ( {A}_{i} , {B}_{i} ) ;$$

$$\overline{KVt} ( {A}_{i} , {B}_{i} ) = {C}_{v} \cdot \overline{Kh} ( {A}_{i} , {B}_{i} ) + ( 1 - {C}_{v} ) \cdot \overline{Kv} ( {A}_{i} , {B}_{i} ) ;$$

$$log ( {Kv}_{j} ( {A}_{i} , {B}_{i} ) ) = ( ( {A}_{i} + dA ) \cdot f ( {φ}_{j} ) + {B}_{i} + dB ) and$$

$$1 \text{/} \overline{Kv} ( {A}_{i} , {B}_{i} ) = {\sum }_{j = 1}^{n} {F}_{j} / {Kv}_{j} ( {A}_{i} , {B}_{i} ) ;$$

$$log ( {Kh}_{j} ( {A}_{i} , {B}_{i} ) ) = ( {A}_{i} \cdot f ( {φ}_{j} ) + {B}_{i} ) and$$

$$\overline{K} h ( {A}_{i} , {B}_{i} ) = {\sum }_{j = 1}^{n} {F}_{j} \cdot {Kh}_{j} ( {A}_{i} , {B}_{i} ) ,$$

and where:
   Cₕ et Cᵥ are positive coefficients lying in the range 0 to 1;
   N is the cardinal number of the determined region of the space defined by the parameters A, B;
   n is the number of intervals of said porosity data distribution;
   Fᵢ is the occurrence frequency associated with each of the intervals of porosity ϕᵢ;
   φ̅ᵢ̅ is the value associated with said porosity intervals;
   K̅ht(Aᵢ, Bᵢ, m, S₁, S₁/S₂) is the total horizontal mean permeability calculated after applying the relationships log(Kh)=(Aᵢ·f(ϕ)+Bᵢ) and log(Kv)=((Aᵢ+dA)·f(ϕ)+Bᵢ+dB) to the probability relationship LP(φ; S₁, . . . , S_{g}) depending on the parameters S₁, . . . , S_{g}; and
   K̅v̅t̅(Aᵢ, Bᵢ, m, S₁, S₁/S₂) is the total vertical mean permeability calculated after applying the relationship log(Kv)=((Aᵢ+dA)·f(ϕ)+Bᵢ+dB) to the probability relationship LP (φ; S₁, . . . , S_{g}) depending on the parameters Sᵢ, . . . , S_{g};
said at least one mean permeability is a total horizontal mean permeability given by one of the formulas:

$$\overline{{Kht}_{S}} ( {A}_{i} , {B}_{i} ) = {\sum }_{j = 1}^{n} {Kht}_{j} ( {A}_{i} , {B}_{i} ) \cdot {LP}_{S} ( {φ}_{j} , {S}_{1} , … , {S}_{g} )$$

where LP_{S} is the probability relationship minimizing the target function; and
said at least one total vertical mean permeability is given by one of the formulas:

$$\overline{{Kvt}_{S}} ( {A}_{i} , {B}_{i} ) = {\sum }_{j = 1}^{n} {Kvt}_{j} ( {A}_{i} , {B}_{i} ) \cdot {LP}_{S} ( {φ}_{j} , {S}_{1} , … , {S}_{g} ) ) .$$

In a particular implementation of the invention, the probability relationship is a normal relationship or a linear combination of normal relationships.

In another particular implementation of the invention, the probability distribution is an asymmetric normal relationship.

It should be recalled that an asymmetric normal relationship LNA(φ) is defined from its mode m, its standard deviation S₁, and its asymmetry coefficient S₁/S₂ by means of the equation:

$$LNA ( ϕ ; \underline{m} , {S}_{1} , {S}_{1} / {S}_{2} ) = \{ \begin{matrix}\frac{1}{\sqrt{2 π {S}_{1}}} \frac{2}{\frac{{S}_{1}}{{S}_{2}} + 1} exp ( - \frac{{( φ - m )}^{2}}{2 {S}_{1}} ) & if φ > m \\ \frac{1}{\sqrt{2 π {S}_{1}}} \frac{2}{\frac{{S}_{1}}{{S}_{2}} + 1} exp ( - \frac{{( φ - m )}^{2}}{2 {{S}_{1} ( \frac{{S}_{1}}{{S}_{2}} )}^{2}} ) & if not\end{matrix} ;$$

m, Sᵢ, and S₂ being three real coefficients.

In a particular implementation of the invention, the coefficient Cₕ is greater than 0.75 and less than 1.

In a particular implementation of the invention, the coefficient Cᵥ is greater than 0 and less than 0.25.

In a particular implementation, the various steps of the estimation method are determined by computer program instructions.

Consequently, the invention also provides a computer program on a data medium, the program being suitable for being performed in a computer, the program including instructions adapted to performing steps of a estimation method as described above.

The program may use any programming language, and be in the form of source codes, object codes, or codes intermediate between source code and object code, such as in a partially compiled form, or in any other desirable form.

The invention also provides a computer-readable data medium including instructions of a computer program as mentioned above.

The data medium may be any entity or device capable of storing the program. For example, the medium may comprise storage means such as a ROM, a RAM, a PROM, an EPROM, a CD ROM, or indeed magnetic recording means, e.g. a floppy disk or a hard disk.

Furthermore, the data medium may be a transmissible medium such as an electrical or optical signal that is conveyed by an electrical or optical cable, by radio, or by other means. The program of the invention may in particular be downloaded from an Internet type network.

Alternatively, the data medium may be an integrated circuit in which the program is incorporated, the circuit being adapted to execute or to be used in the execution of the method in question.

The invention also provides an estimation device for estimating at least a mean permeability for a set of wells of an underground reservoir, the device comprising:
an obtaining module for obtaining a porosity data distribution for the set of wells;
a determination device of the invention for determining a plurality of first relationships associating porosity with permeability for the set of wells;
an obtaining module for obtaining a probability relationship approximating the distribution on the basis of at least said plurality of first relationships; and
an estimation module for estimating the mean permeability for the set of wells from at least the asymmetric normal relationship and said plurality of first relationships.

The estimation device is configured to perform the estimation method as defined above.

In yet another aspect, the present invention also provides a calculation method for calculating a mean permeability at a location of an underground reservoir. The method comprises:
a selection step for selecting a set of wells of the reservoir, the set of wells comprising at least one well;
a determination step for determining a plurality of first relationships associating permeability with porosity for the set of wells using a determination method of the invention;
for each of the wells in the set of wells:
   an obtaining step for obtaining a porosity data distribution for the well; and
   an obtaining step for obtaining a probability relationship approximating the distribution on the basis of at least the plurality of first relationships;
a calculation step for calculating a probability relationship at the location from the probability relationship obtained for each of the wells; and
a calculation step for calculating the mean permeability at the location from at least the probability relationship at the location and from at least the plurality of first relationships.

The invention thus makes it possible to estimate the permeability distribution at any point in a reservoir from a plurality of φ-K relationships and using a model in the form of probability relationships for porosity distributions at a plurality of wells in an underground reservoir.

In a particular implementation, the calculation method further comprises a calculation step for calculating a mean porosity at the location from at least the probability relationship at the location.

In a particular implementation, the various steps of the method of calculating a mean permeability are determined by computer program instructions.

Consequently, the invention also provides a computer program on a data medium, the program being suitable for being performed in a computer, the program including instructions adapted to performing steps of a method of calculating a mean permeability as described above.

The program may use any programming language, and be in the form of source codes, object codes, or codes intermediate between source code and object code, such as in a partially compiled form, or in any other desirable form.

The invention also provides a computer-readable data medium including instructions of a computer program as mentioned above.

The data medium may be any entity or device capable of storing the program. For example, the medium may comprise storage means such as a ROM, a RAM, a PROM, an EPROM, a CD ROM, or indeed magnetic recording means, e.g. a floppy disk or a hard disk.

Furthermore, the data medium may be a transmissible medium such as an electrical or optical signal that is conveyed by an electrical or optical cable, by radio, or by other means. The program of the invention may in particular be downloaded from an Internet type network.

Alternatively, the data medium may be an integrated circuit in which the program is incorporated, the circuit being adapted to execute or to be used in the execution of the method in question.

The invention also provides a device for calculating a mean permeability at a location of an underground reservoir. The device comprises:
a selector module for selecting a set of wells of the reservoir, the set comprising at least one well;
a determination device for determining a plurality of first relationships associating permeability with porosity for the set of wells;
an obtaining module for obtaining a porosity data distribution for each of the wells of the set;
an obtaining module for obtaining a probability relationship approximating the distribution for each of the wells of the set on the basis of at least the plurality of first relationships;
a calculation module for calculating a probability relationship at the location from the probability relationship obtained for each of the wells; and
a calculation module for calculating the mean permeability at the location from at least the probability relationship at the location and from at least the plurality of first relationships.

### BRIEF DESCRIPTION OF THE DRAWINGS

Particular characteristics and advantages of the present invention appear from the detailed description given below with reference to the accompanying figures, in which:

FIG. 1, described above, shows an underground hydrocarbon reservoir;

FIG. 2 shows an example of hardware architecture for a device of the invention for determining a plurality of first relationships associating permeability with porosity within an underground reservoir;

FIG. 3 is a flow chart showing the main steps of a determination method for determining a plurality of first relationships associating permeability with porosity within an underground reservoir, the method being in compliance with the invention in a first implementation variant;

FIG. 4 shows graphically the various steps of a method of determining a plurality of first relationships associating permeability with porosity within an underground reservoir in a first implementation variant;

FIG. 5 is a flow chart showing the main steps of a method of adding additional measurement points;

FIG. 6 shows graphically a theoretical overall distribution associated with permeability measurements obtained from formation tests and a distribution associated with permeability measurements obtained from analyzing sample cores;

FIG. 7 is a flow chart showing the main steps of a determination method for determining a plurality of first relationships associating permeability with porosity within an underground reservoir, the method being in accordance with the invention in a second implementation variant;

FIG. 8 shows graphically certain steps of a determination method for determining a plurality of first relationships associating horizontal and vertical permeabilities with porosity within an underground reservoir in a second implementation variant;

FIG. 9 shows an example of hardware architecture for a device of the invention for estimating mean permeability along a portion of a well in an underground reservoir;

FIG. 10 is a flow chart showing the main steps of an estimation method for estimating mean permeability along a portion of a well in an underground reservoir, the method being in accordance with the invention in a first implementation variant;

FIG. 11 shows an underground hydrocarbon reservoir and a distribution of porosity data associated with a well;

FIG. 12 is a flow chart showing the main steps of an estimation method for estimating total horizontal mean permeability along a portion of a well of an underground reservoir, the method being in compliance with the invention in a second implementation variant;

FIG. 13 shows an example of hardware architecture for a device of the invention for calculating mean permeability at a point in an underground reservoir; and

FIG. 14 is a flow chart showing the main steps of a calculation method for calculating mean permeability at a point in an underground reservoir, the method being in accordance with the invention in a first implementation variant.

### DETAILED DESCRIPTION OF THE INVENTION

In the following examples, the wells that are described are vertical wells. As an alternative, it is equally possible to implement the invention in the context of wells that are not vertical.

FIG. 2 shows a determination device 3 for determining a plurality of first relationships associating permeability with porosity within an underground reservoir in a particular embodiment of the invention. The determination device 3 has the hardware architecture of a computer.

Thus, the determination device 3 comprises in particular a processor 3A, a ROM 3B, a RAM 3C, a non-volatile memory 3D, and communication means 3E.

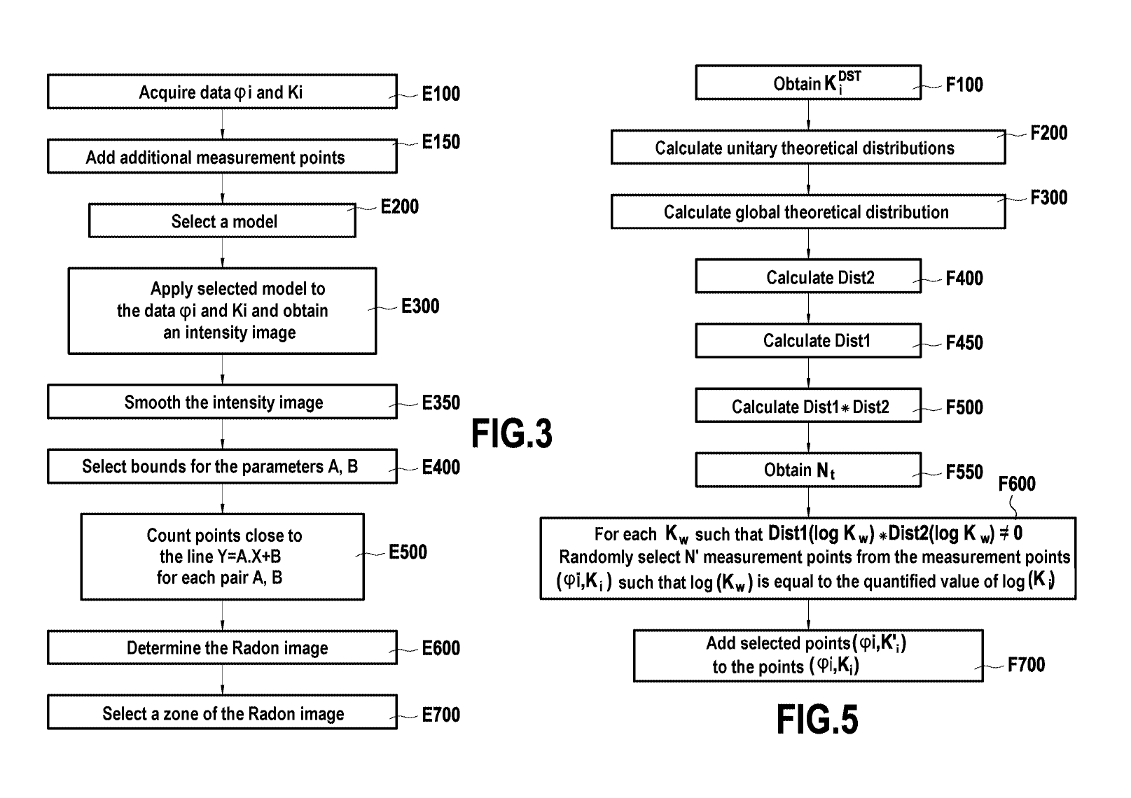

The ROM 3B of the determination device constitutes a data medium readable by the processor 3A and storing a computer program in accordance with the invention including instructions for executing steps of a determination method of the invention for determining a plurality of first relationships associating permeability with porosity within an underground reservoir, the steps of the determination method being described below with reference to FIG. 3 in a particular implementation.

In equivalent manner, the computer program defines functional modules of the determination device, such as in particular an obtaining module 3B1 for obtaining a plurality of measurement points comprising a porosity data value and a first permeability data value, a definition module 3B2 for defining a family of relationships associating porosity with at least one permeability, a first counter module 3B3 for each relationship of the family of relationships, for counting measurement points of the plurality of points that are reproduced by the relationship so as to obtain a first intensity of points associated with each relationship, and a selector module 3B4 for selecting a plurality of first relationships from the family of relationships on the basis of at least the result of the counting performed by the first counter module. The obtaining module 3B1 for obtaining a plurality of measurement points makes use in particular of the communication means 3E.

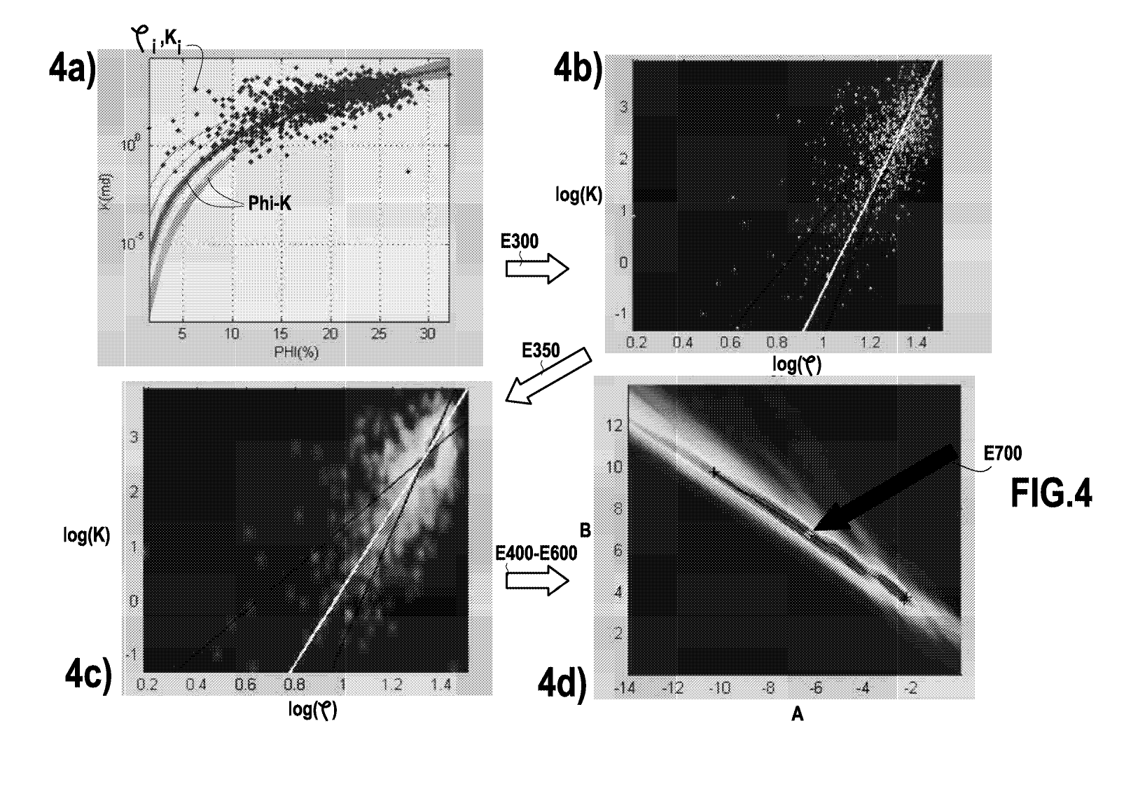

There follows a description with reference to FIG. 3 of the main steps of a first implementation of a determining method of the invention, this implementation being performed by the determination device 3. FIG. 3 may be read with reference to FIGS. 4a) to 4d), which show graphically the various steps of the method of FIG. 3.

It is assumed that during a step E100, the determination device 3 acquires a set of measurements of permeability (specifically of a “first” permeability in the meaning of the invention) and of porosity within the reservoir 1.

By way of example, the porosity as acquired in this way may comprise measurements of useful porosity obtained by applying a cutoff. In other words, the measurements of useful porosity are measurements of porosity lying within a range of porosity values defined by a low threshold.

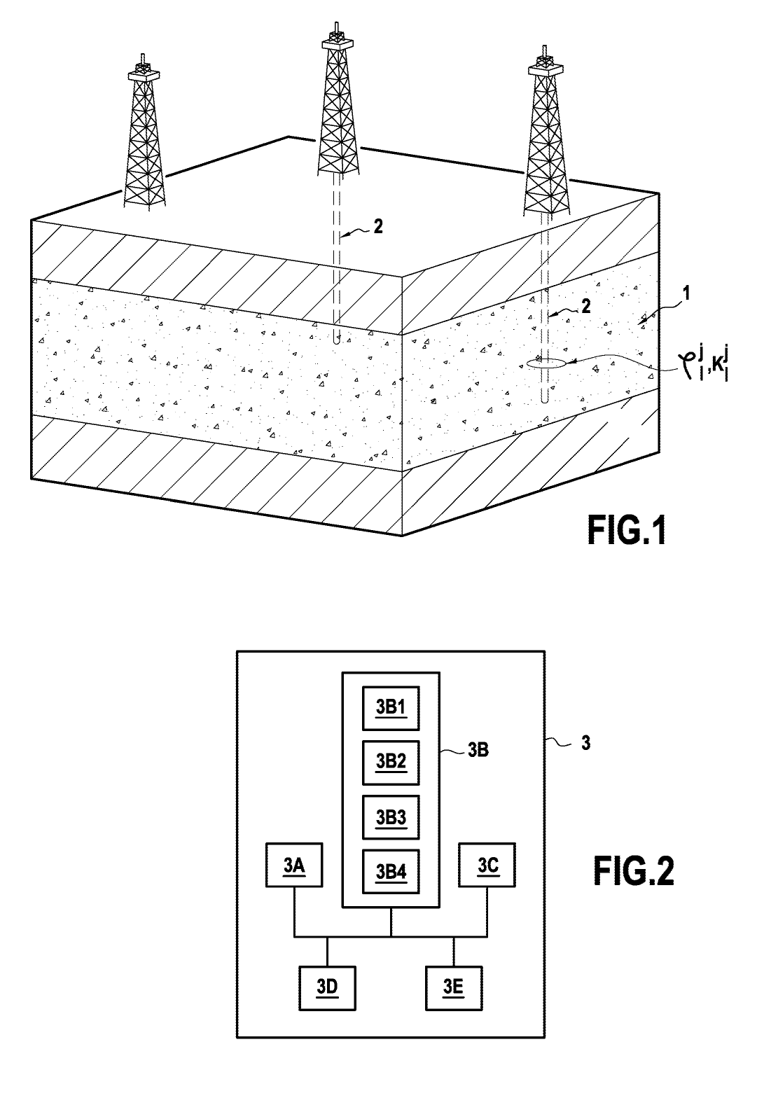

With reference to FIG. 1, this set of measurements of porosity φᵢ and of permeability Kᵢ is constituted by way of example by all of the discrete measurements ϕₗ^{j} and Kₗ^{j} taken by analyzing cores taken from the reservoir-rock 1 for a set of wells 2. In this example, j is an index corresponding to a well, and l is an index corresponding to a vertical position along the well. A pair φₗ^{j},Kₗ^{j} is measured in a cylindrical portion of the well.

In a variant, the measurements φᵢ may be obtained by analyzing results of logging performed within the reservoir 1.

In the presently-described example, the set of measurements φᵢ, Kᵢ is obtained at the scale of the reservoir 1.

In a variant, the set of measurements φᵢ, Kᵢ is obtained at the scale of a subset of the wells of the reservoir 1.

In FIG. 4a), there can be seen a cloud of measurement points, each corresponding to a pair φᵢ, Kᵢ that has previously been measured.

In the presently-described example, the permeability measurements Kᵢ are horizontal permeability measurements.

In a variant, the permeability measurements Kᵢ could be vertical permeability measurements.

In the presently-described implementation, additional measurement points φᵢ, K′ᵢ are added to the measurement point during a step E150. In the description below, the added measurement points φᵢ, K′ᵢ are also written φᵢ. Kᵢ.

A detailed implementation of the step E150 is shown in non-limiting manner in FIG. 5, which is described below.

During a step E200 of the method, a semi-log or log-log model is selected as a function of the intrinsic nature of the rock constituting the reservoir 1. In the presently-described example, the model selected during this step and corresponding best to the properties of the rock constituting the reservoir is a log-log model.

Thus, the family of φ-K relationships is defined by the equation log(K)=B·log(q))+A, depending on two parameters A and B.

Thereafter, a new cloud of points log(φᵢ), log(Kᵢ) is obtained in step E300, as shown in FIG. 4b).

FIG. 4b) shows the cloud of points log(φᵢ), log(Kᵢ) in the form of an intensity image, the value of each of the points in this image being proportional to the number of observed data points log(φᵢ), log(Kᵢ).

This image may optionally be smoothed during a step E350, e.g. by performing Gaussian filtering, so as to be easier to use.

During a step E400, low and high bounds are selected for the coefficients A and B. This selection may be carried out as a function of the usual values for the parameters of φ-K relationships.

In the example of FIG. 4d), A lies in the range −14 to 0, and B lies in the range 0 to 14. The inventors have observed that selecting these low and high bounds for the coefficients A and B is satisfactory, both when the measurements of permeability Kᵢ are measurements of vertical permeability, and when the measurements of permeability Kᵢ are measurements of horizontal permeability.

For each pair of coefficients A and B, in the context of these bounds, the straight line of equation y=A·x+B is determined in the space of the log(φ), log(K) representation of FIG. 4c), and log(φᵢ), log(kᵢ) points of distance from the straight line under consideration that is less than a threshold (e.g. estimated from the resolution of the intensity image) are counted during a step E500.

In order to take account of the distribution of points along the straight line in question, the result of the count may optionally, but advantageously, be multiplied by the product of the variance σ(log(φᵢ)) as evaluated on all of the cloud of points of the distances to the model of each of the points along the log(φ) axis, multiplied by the variance σ(log(Kᵢ)) as evaluated for all of the cloud of points for the distances to the curve representing the φ-K relationship for each of the points along the log(K) axis.

The value obtained for each pair A, B is representative of the match between the φ-K relationship and the cloud of points, and in the implementation in which the result is weighted by the above-mentioned product of variances, the value obtained increases if the cloud of points is distributed along the line representing the φ-K relationship in the log(φ), log(K) representation space.

During a step E600, for each pair A, B within the limits defined by the minimum and maximum bounds for these variables in step E400, the result of the counting, possibly weighted as mentioned above, is converted into the form of an intensity associated with the corresponding points in the space of the values A, B.

FIG. 4d) is in the form of a gray scale image known as a “Radon” image, showing the intensities that are obtained in the space of the values A, B. On a graphics interface, it is possible in a variant to use color coding or brightness to represent the resulting intensity. It may be observed that the image is not strictly speaking a Radon image, however that term is used by way of analogy.

Thereafter, during a step E700, a region in the (A, B) space is selected that corresponds to a set of relationships describing the relationship between log(q) and log(K) and corresponding to acceptable φ-K relationships. By way of example, this selection is performed by selecting all of the intensities that exceed a threshold, e.g. as set by the user.

In a variant, the sum of intensities in the space of the values A, B as shown in FIG. 4d) is normalized to unity. In other words, each of the intensities in the space of the values A, B under consideration (i.e. in this example A lying in the range −14 to 0, B lying in the range 0 to 14) is divided by the sum of all of the intensities in this space of values. This produces a probability distribution with two variables A and B, and a region of the (A, B) space is selected by selecting all of the points corresponding to a cumulative probability threshold, e.g. 10%, which threshold may for example be determined as a function of the nature of the reservoir.

Unlike the prior art, in which a regression is performed in order to provide a single φ-K relationship, the estimation method of the invention makes it possible to obtain a probabilistic set of φ-K relationships that is more representative of the distribution of the measurements of porosity and permeability.

FIG. 4a) thus shows a plurality of φ-K relationships obtained by the estimation method.

It should be observed that the calculation of (A, B) φ-K relationships described above for a log-log model is equally applicable to a semi-log model or to any other model that may be selected by the person skilled in the art by replacing the log(φ), log(K) representation space of FIGS. 4b) and 4c) with a suitable representation space, e.g. a φ, log(K) space for the semi-log model.

With reference to FIG. 5, there follows a detailed description of how the step E150 is implemented, which consists in adding a set of additional measurement points to the set of existing measurement points (φᵢ, Kᵢ).

During the step F100, a permeability data series Kᵢ^{DST} (constituting second permeability values in the meaning of the invention) associated with an uncertainty σᵢ^{DST} is obtained by interpreting measurements taken from formation tests carried out within the reservoir 1.

For each of these values, a unitary theoretical distribution of the logarithm of the permeability is calculated (step F200) by convolution of the data points with a Gaussian distribution of mean (log(Kᵢ^{DST}), having a standard deviation log(σᵢ^{DST}) and of amplitude that is calculated in such a manner that the integral over R of the Gaussian distribution is equal to 1.

The unitary theoretical distributions associated with each of the permeability values Kᵢ^{DST} are then added in a step F300 in order to form a global theoretical distribution.

During a step F400, the determination device also calculates the distribution of the logarithm of the values Kᵢ of the existing measurement points, which distribution is then quantified in order to obtain a real histogram Dist2.

In the presently-described implementation, the quantification is uniform scalar quantification, with the quantification stepsize and the decision levels being selected by a reservoir engineer or by a geologist, for example.

In another implementation, the quantification used is non-uniform scalar quantification.

During a step F450, the global theoretical distribution is quantified in order to obtain a global theoretical histogram Dist1, with this discretization being performed using the same quantification stepsize and the same decision levels as for quantification of the distribution of the logarithm of the values Kᵢ. In other words, the classes (i.e. the intervals) of the histogram Dist1 are equal to the classes of the histogram Dist2.

Thereafter (step F500), the determination device 3 calculates the probability-normalized product (i.e. the integral over R of the product is normalized relative to 1) of the two histograms Distl and Dist2 in order to identify their intersection.

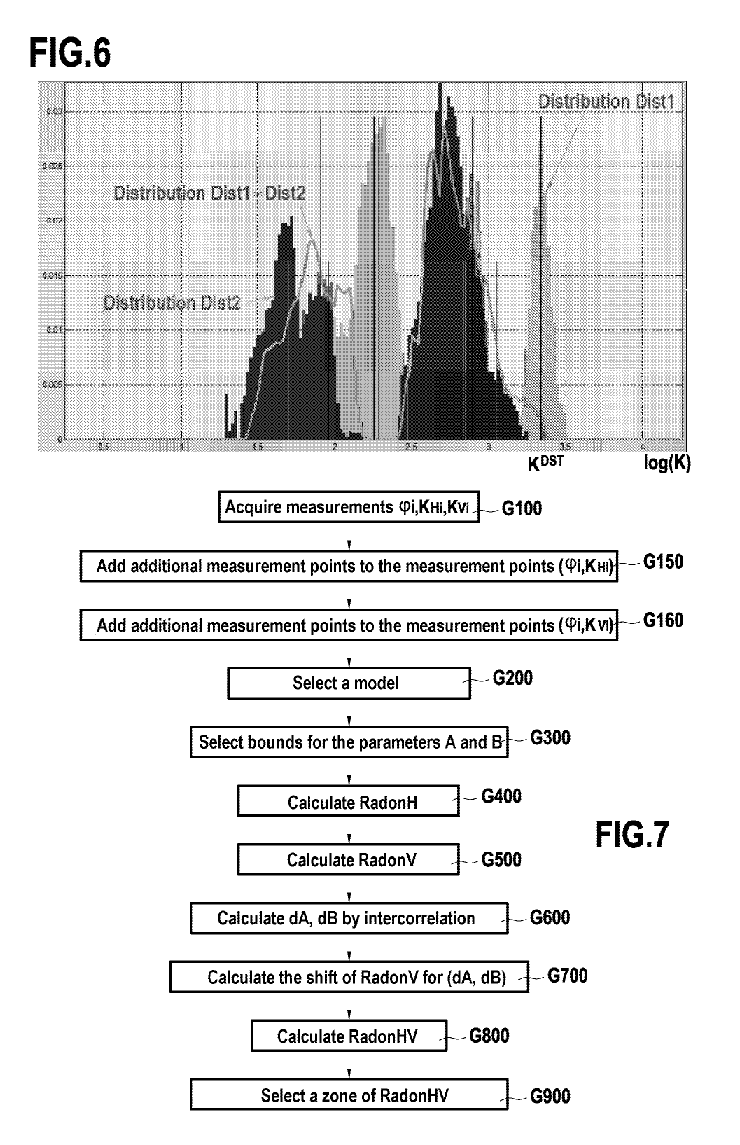

FIG. 6 shows a global theoretical histogram Distl (representative of data obtained from formation tests), a histogram Dist2 of the logarithm of the values Kᵢ (representative of the data obtained by analyzing sample cores or by logging), together with the product of these two histograms.

The intersection of the two histograms Dist1 and Dist2 serves to identify permeability measurements coming from the analysis of sample cores that corroborate permeability measurements coming from analyzing formation tests.

During a step F550, the determination device 3 acquires a total number Nₜ of additional measurement points to be added to the existing measurement points (φᵢ, Kᵢ).

For each of the intervals w associated with a log(K_{w}) value for which there is a non-zero intersection of the two distributions Dist1 and Dist2, the determination device 3 determines a number N′ of additional measurement points (step 550) and randomly selects N′ additional measurement points (step F600) from the set of existing measurement points (φᵢ, Kᵢ) for which log (K_{w}) is equal to the quantified value of log(Kᵢ).

It should be observed that the number N′ is determined as being the product of the value of the products of the two distributions Dist1 and Dist2 evaluated over the interval w multiplied by the total number Nₜ of additional measurement points to be added to the existing measurement points (φᵢ, Kᵢ).

The previously selected additional measurement points are then added to the measurement points (φᵢ, Kᵢ) during a step F700.

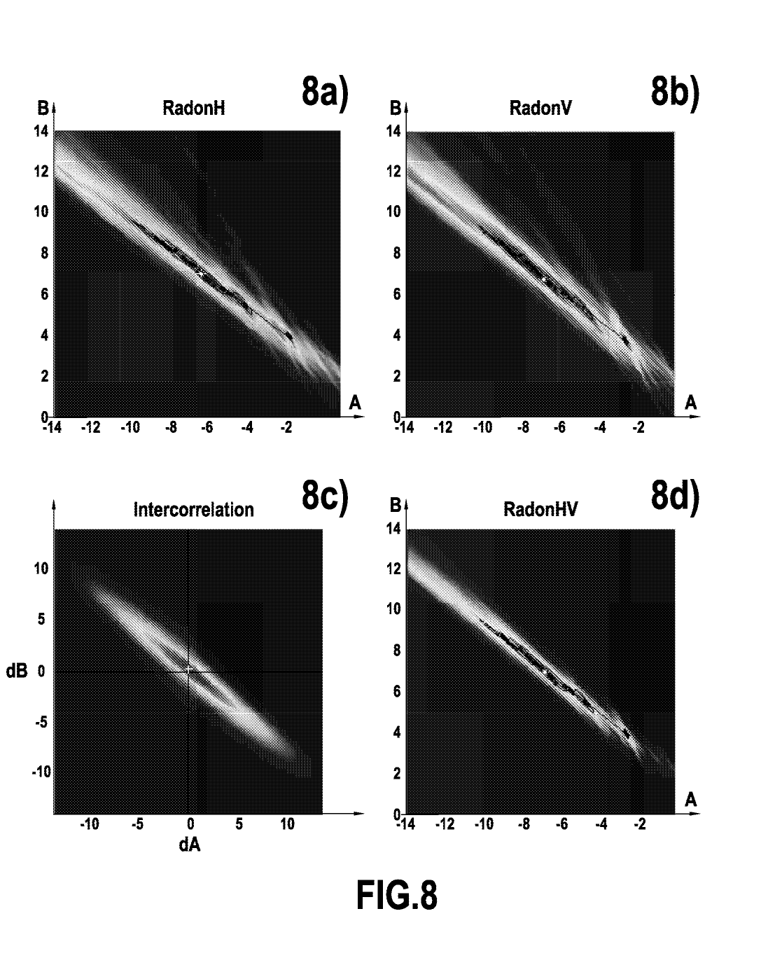

With reference to FIGS. 7 and 8, there follows a description of the main steps of a determination method of the invention in a second implementation that is likewise performed by the determination device 3.

It is assumed that during a step G100, the determination device 3 acquires a set of measurements of porosity, of horizontal permeability (of “first” permeability data in the meaning of the invention), and of vertical permeability (of “third” permeability data in the meaning of the invention) within the reservoir 1. With reference to FIG. 1, this set of measurements of porosity φᵢ, of horizontal permeability K_{Hi}, and of vertical permeability Kᵥᵢ is constituted by way of example by the set of discrete measurements ϕₗ^{j}, K_{Hl}^{j}, K_{Vl}^{j} taken by analyzing cores extracted from the reservoir-rock 1 for a set of points 2. In this example, j is an index corresponding to a well and l is an index corresponding to a vertical position along the well. The φₗ^{j}, K_{Hl}^{j}, K_{Vl}^{j} triplet is measured in a portion of the cylinder of the well.

In the presently-described implementation, additional measurement points are added to the measurement points φᵢ, K_{Hi} during the step G150. Likewise, additional measurement points are added to the measurement points (φᵢ, K_{Vi}) during the step G160.

In a variant, no additional measurement point is added to the measurement points (φᵢ, K_{Hi}).

In another variant, no additional measurement point is added to the measurement points (φᵢ, K_{Vi}).

It should be observed that formation tests make it possible to obtain horizontal permeability values K′^{Hi} and vertical permeability values K′_{Vi}, which values are obtained by tests of the modular dynamic tester (MDT) type or by using measurements of the repeat formation tester (RFT) type.

The step G150 and the step G160 are performed in similar manner to the step E150 as illustrated in non-limiting manner in above-described FIG. 5.

During a step G200 of the method, a model, e.g. a semi-log or a log-log model, is selected as a function of the intrinsic nature of the rock constituting the reservoir 1. In the presently-described example, the model selected during this step and corresponding best to the properties of the rock constituting the reservoir is a semi-log model.

Thus, the family of φ-K relationships is defined by the equation log(K)=A·φ+B that depends on the two parameters A and B.

During a step G300, low and high bounds are selected for the coefficients A and B. This selection may be made as a function of the parameters of usual φ-K relationships. In the presently-described example, A lies in the range −14 to 0, and B lies in the range 0 to 14.

Thereafter, during a step G400, the determination device 3 calculates the horizontal Radon image, written RadonH, for the data pairs φᵢ, K_{Hi}. More precisely, during this step G400, the cloud of φᵢ, log(K_{Hi}) points is represented in the form of an optionally filtered intensity image. For each pair of values A and B, the points φᵢ, log(K_{Hi}) at a distance from the straight line of equation y=A·x+B in the space of the (p, log(K) representation is below a threshold, e.g. estimated from the resolution of the intensity image, are counted and the possibly-weighted result of the counting is represented in the form of an intensity associated with the corresponding point in the Radon space of the values A, B.

Likewise, during a step G500, the determination device 3 calculates the vertical Radon image, written RadonV, of the data pairs φᵢ, K_{Vi} by counting the points log(Kᵥᵢ) at a distance from the straight line having the equation y=A·x+B in the space of the φ, log(K) representation that is below a threshold, e.g. as estimated from the resolution of the intensity image.

FIG. 8(a) represents the RadonH image associated with the data pairs φᵢ, K_{Hi}, while FIG. 8(b) represents the RadonV image associated with the data pairs φᵢ, K_{Vi}.

Thereafter, during a step G600, the determination device 3 calculates the intercorrelation between the RadonH and RadonV images and identifies a maximum in this intercorrelation signal. This intercorrelation is shown in FIG. 8(c) together with the location (dA, dB) of its maximum value.

Thereafter, in a step G700, the determination device 3 shifts the RadonV image along a translation vector (dA, dB) prior to calculating the RadonHV image corresponding to the product of the RadonH image multiplied by the shifted RadonV image (step G800). A RadonHV image is shown in FIG. 8(d).

Thereafter, during a step G900, a region of the (A, B) space is selected that corresponds to the set of relationships between φ and log(K_{H}) that correspond to acceptable φ-K relationships. By way of example, this selection may be performed by selecting all intensities exceeding a threshold, which threshold may be set previously by the user, or a probability if the image has been normalized (the sum of the pixels of the image being equal to 1).

All φ-K relationships that acceptably describe the relationship between φ and log(K_{V}) correspond to using a translation vector (dA, dB) to shift the parameters A and B corresponding to the region previously.

In the presently-described example, the same low and high bounds are selected for the coefficients A and B when determining the images RadonH and RadonV.

In a variant, different bounds could be used when determining the images RadonH and RadonV, providing the RadonV image is interpolated over the coordinates of the RadonH image prior to calculating the intercorrelation between the two images.

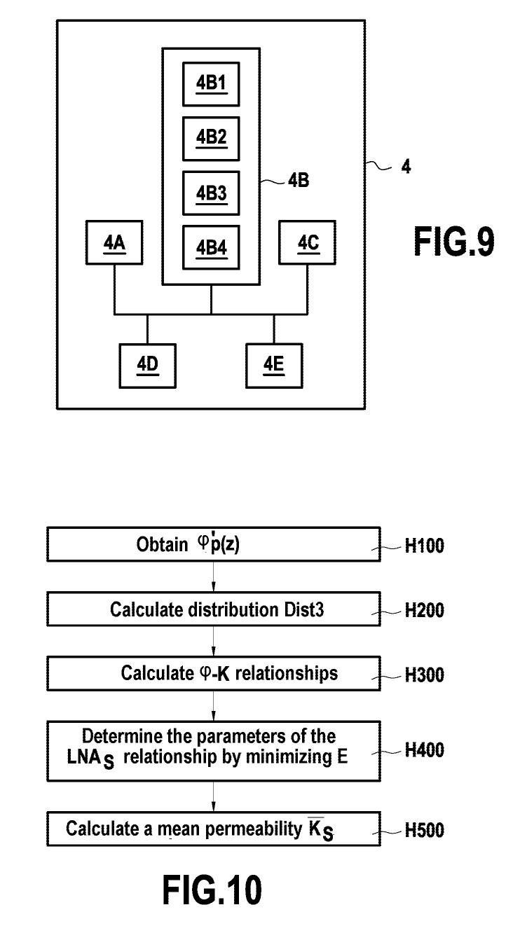

With reference to FIG. 9, there follows a description of an estimator device 4 for estimating mean permeability along a portion S of a well 2 in a particular embodiment of the invention.

In this example, mean permeability along the well is obtained by using an asymmetric normal relationship. That said, other probability relationships could be used.

The estimator device 4 has the hardware architecture of a computer. Thus, the estimator device 4 comprises in particular a processor 4A, a ROM 4B, a RAM 4C, a non-volatile memory 4D, and communication means 4E.

The ROM 4B of the estimator device constitutes a data medium that is readable by the processor 4A and storing a computer program in accordance with the invention including instructions for executing steps of an estimation method for estimating a mean permeability within an underground reservoir in accordance with the invention, the steps of this estimation method being described below with reference to FIG. 9 in a particular implementation.

In equivalent manner, the computer program defines functional modules of the estimator device, such as in particular an obtaining module 4B1 for obtaining a porosity data distribution for the portion of the well, a determination device 4B2 for determining a plurality of first relationships associating porosity with permeability for the portion of the well in accordance with the invention, an obtaining module 4B3 for obtaining an asymmetric normal relationship approximating the porosity data distribution on the basis of at least said plurality of first relationships, and an estimator module 4B4 for estimating the mean permeability along the portion of the well from at least the asymmetric normal relationship and said plurality of first relationships. The obtaining module 4B1 for obtaining a porosity data distribution for the portion of the well and the determination device make use in particular of the communication means 4E.

With reference to FIG. 10, there follows a description of the main steps of a method of estimating mean permeability for a well 2 of the reservoir 1 in a first implementation in which the method is performed by an estimator device 4.

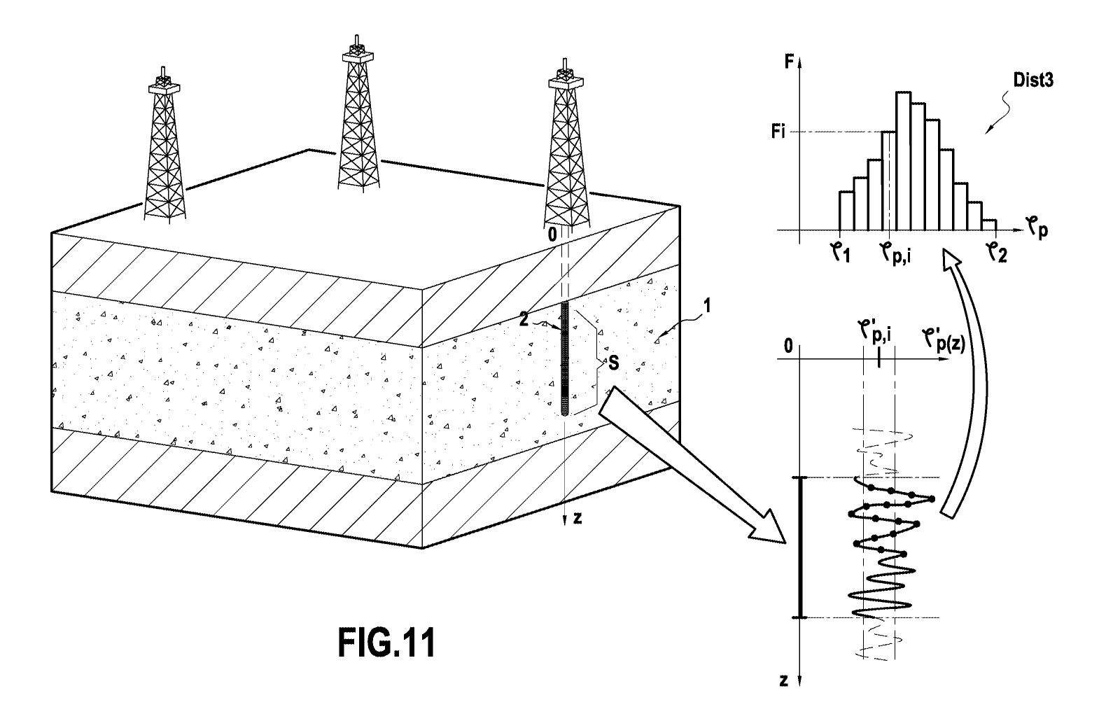

With reference also to FIG. 11 while reading FIG. 10, the estimator device acts during a step H100 to acquire a measurement of permeability φ′(z) along the portion S of the well 2, e.g. from a set of logs taken in the well 2. In known manner, the logs measure physical parameters that are associated by the relationships of physics with the porosity of the reservoir. On the basis of these parameters, mathematical methods of optimization or of inversion are used in order to find the continuous function φ′(z) that represents porosity as a function of depth and that provides the best explanation for the logging measurements.

In a variant, porosity φ′(z) along the portion S of the well 2 may be measured by analyzing sample cores, providing the corresponding porosity measurements are representative, i.e. regular and not spaced too far apart along the axis z.

During a step H200, a porosity data histogram φ′(z) is obtained. In other words, the porosity data φ′(z) obtained in step H100 is quantified, e.g. by a uniform scalar quantifier. The experimental histogram Dist3 of this discretized data, an example of which is shown in FIG. 11, is characterized by the frequencies Fᵢ of the occurrences of each of the quantified data values ϕᵢ′ representative of each of the intervals of the histogram. It should be observed that by definition the histogram is normalized so that the following relationship:

$${\sum }_{i = 1}^{n} {F}_{i} = 1$$

is satisfied.

In the presently-described example, the estimator device acts during step H300 to calculate a set of φ-K relationships associating porosity with horizontal permeability for the section S of the well by applying a determination method in accordance with the invention for determining such a set of relationships. The φ-K relationships obtained in this way are expressed in the form log(Kh)=(Aᵢ·f(ϕ′)+Bᵢ) where Kh is a horizontal permeability, Aᵢ and Bᵢ are two real parameters belonging to a determined region of cardinal number N of the space defined by the parameters A, B, and where f is the function f(φ′)=φ′ or the function f(φ′)=log(φ′) or any other mathematical function.

Thereafter, during a step H400, the estimator device determines the parameters of the asymmetric normal relationship LNA_{S} (φ′; m_{S}, S_{1,s}, S_{1,s}/S_{2,s}) that minimizes a target function E=αE₁+(1−α)[(1−β)E₃+βE₂], where α and β are two positive coefficients that are less than one, and where:
the term

$${E}_{1} = {\sum }_{i = 1}^{n} {( {F}_{i} - LNA ( {φ}_{i}^{′} , m , {S}_{1} , {S}_{1} / {S}_{2} ) )}^{2}$$

favors asymmetric normal relationships that best approximate the experimental porosity distribution;
the term

E₂=(ϕ̅ᵢ̅′̅−L̅N̅A̅(m,S₁,S₁/S₂))²

favors asymmetric normal relationships LNA(m, S₁, S₁/S₂) of mean value L̅N̅A̅(m, S₁, Sᵢ/S₂) that best corresponds to the mean value φ̅ᵢ̅′̅ of the porosity measurements; and
the term

$${E}_{3} = {\sum }_{i = 1}^{N} {( \overline{K} h ( {A}_{i} , {B}_{i} ) - \overline{K} h ( {A}_{i} , {B}_{i} , m , {S}_{1} , {S}_{1} / {S}_{2} ) )}^{2}$$

favors asymmetric normal relationships for which the values of the horizontal mean permeability as defined by the equation

$$\overline{K} h ( {A}_{i} , {B}_{i} ) = {\sum }_{j = 1}^{n} {Kh}_{j} ( {A}_{i} , {B}_{i} , {φ}_{j}^{′} ) \cdot {F}_{j}$$

calculated by applying the relationship

log(Khⱼ(Aᵢ,Bᵢ,ϕⱼ′))=(Aᵢ·f(φ′ⱼ)+Bᵢ)

to the experimental porosity data φᵢ′ are close to the horizontal mean permeability values K̅h̅(Aᵢ, Bᵢ, m, S₁, S₁/S₂) calculated after applying the relationship log log(Kh)=(Aᵢ·f(ϕ′)+Bᵢ) to the asymmetric normal relationship LNA(φ′; m, S₁, S₁/S₂) approximating the experimental porosity data.

The target function E is minimized, e.g. by using the method of conjugate gradients using as the initial point (m, S₁, Sᵢ/S₂)=(ϕ̅ᵢ̅′̅, σ²(φᵢ′), 1) where φ̅ᵢ̅′̅ represents the mean value of the data values ϕᵢ′ and σ²(ϕᵢ′) represents their standard deviation.

During step H500, at least one horizontal mean permeability K̅h̅_{S} is estimated for the portion S of the well 2 from the optimum asymmetric normal relationship determined during the step H400 and from the set of φ-K relationships associating porosity with horizontal permeability for the section S of the well.

In other words, the horizontal mean permeability K̅h̅_{S} is determined by at least one pair (Aᵢ, Bᵢ) from the equation:

$$\overline{{Kh}_{S}} ( {A}_{i} , {B}_{i} ) = {\sum }_{j = 1}^{n} exp ( {A}_{i} \cdot f ( {φ}_{j}^{′} ) + {B}_{i} ) \cdot {LNA}_{S} ( {φ}_{j}^{′} , {m}_{S} , {S}_{1 , s} , \frac{{S}_{1 , s}}{{S}_{2 , s}} )$$

In the above-described embodiment, the estimator device estimates a horizontal mean permeability.

In another embodiment, the estimator device estimates a vertical mean permeability by:
acting during step H400 to minimize a target function E in which the third term E3 is equal to:

$${\sum }_{i = 1}^{N} {( \overline{K} v ( {Av}_{i} , {Bv}_{i} ) - \overline{K} v ( {Av}_{i} , {Bv}_{i} , m , {S}_{1} , {S}_{1} / {S}_{2} ) )}^{2}$$

$$with$$

$$log ( {Kv}_{j} ( {Av}_{i} , {Bv}_{i} , {φ}_{j}^{′} ) ) = ( {A}_{i} \cdot f ( {φ}_{j}^{′} ) + {B}_{i} )$$

$$and$$

$$1 / \overline{Kv} ( {Av}_{i} , {Bv}_{i} ) = {\sum }_{j = 1}^{n} {F}_{j} / {Kv}_{j} ( {Av}_{i} {Bv}_{i} , {φ}_{j}^{′} )$$

and then during step H500, calculating at least one vertical mean permeability from the equations:

$$1 / \overline{{Kv}_{S}} ( {Av}_{i} , {Bv}_{i} ) = {\sum }_{j = 1}^{n} {LNA}_{S} ( {φ}_{j}^{′} , m , {S}_{1} , \frac{{S}_{1}}{{S}_{2}} ) / exp ( {Av}_{i} \cdot f ( {φ}_{j}^{′} ) + {Bv}_{i} )$$

In another embodiment, the estimator device estimates a total horizontal mean permeability by:
acting during the step H400 to minimize a target function E in which the third term E3 is equal to:

$${\sum }_{m = 1}^{M} {\sum }_{i = 1}^{N} {( \overline{K} ht ( {A}_{i} , {B}_{i} , {Av}_{m} , {Bv}_{m} ) - \overline{Kht} ( {A}_{i} , {B}_{i} , {Av}_{m} , {Bv}_{m} , m , {S}_{1} , {S}_{1} / {S}_{2} ) )}^{2}$$

$$with$$

$$\overline{Kht} ( {A}_{i} , {B}_{i} , {Av}_{m} , {Bv}_{m} ) = {C}_{h} \cdot \overline{Kh} ( {A}_{i} , {B}_{i} ) + ( 1 - {C}_{h} ) \cdot \overline{Kv} ( {Av}_{m} , {Bv}_{m} )$$

$$log ( {Kv}_{j} ( {Av}_{m} , {Bv}_{m} , {φ}_{j}^{′} ) ) = ( {Av}_{m} \cdot f ( {φ}_{j}^{′} ) + {Bv}_{m} )$$

$$1 / \overline{Kv} ( {Av}_{m} , {Bv}_{m} ) = {\sum }_{j = 1}^{n} {F}_{j} / {Kv}_{j} ( {Av}_{m} , {Bv}_{m} , {φ}_{j}^{′} )$$

$$log ( {Kh}_{j} ( {A}_{i} , {B}_{i} , {φ}_{j}^{′} ) ) = ( {A}_{i} \cdot f ( {φ}_{j}^{′} ) + {B}_{i} )$$

$$\overline{K} h ( {A}_{i} , {B}_{i} ) = {\sum }_{j = 1}^{n} {F}_{j} \cdot {Kh}_{j} ( {A}_{i} , {B}_{i} , {φ}_{j}^{′} )$$

and where 0.75<Cₕ<1 (the low bound of this coefficient being determined for example by the user as a function of the nature of the reservoir) and, during the step H500, calculating at least one total horizontal mean permeability from the equations:

$$\overline{{Kht}_{S}} ( {A}_{i} , {B}_{i} , {Av}_{m} , {Bv}_{m} ) = {\sum }_{j = 1}^{n} {Kht}_{j} ( {A}_{i} , {B}_{i} , {Av}_{m} , {Bv}_{m} , {φ}_{j}^{′} ) \cdot {LNA}_{S} ( {φ}_{j}^{′} , m , {S}_{1} , \frac{{S}_{1}}{{S}_{2}} )$$

In another embodiment, the estimator device estimates a total vertical mean permeability by:
acting during the step H400 to minimize a target function E in which the third term E3 is equal to:

$${\sum }_{m = 1}^{M} {\sum }_{i = 1}^{N} {( \overline{K} vt ( {A}_{i} , {B}_{i} , {Av}_{m} , {Bv}_{m} ) - \overline{Kvt} ( {A}_{i} , {B}_{i} , {Av}_{m} , {Bv}_{m} , m , {S}_{1} , {S}_{1} / {S}_{2} ) )}^{2}$$

$$with$$

$$\overline{Kvt} ( {A}_{i} , {B}_{i} , {Av}_{m} , {Bv}_{m} ) = {C}_{v} \cdot \overline{Kh} ( {A}_{i} , {B}_{i} ) + ( 1 - {C}_{v} ) \cdot \overline{Kv} ( {Av}_{m} , {Bv}_{m} )$$

$$log ( {Kv}_{j} ( {Av}_{m} , {Bv}_{m} , {φ}_{j}^{′} ) ) = ( {Av}_{m} \cdot f ( {φ}_{j}^{′} ) + {Bv}_{m} )$$

$$1 / \overline{Kv} ( {Av}_{m} , {Bv}_{m} ) = {\sum }_{j = 1}^{n} {F}_{j} / {Kv}_{j} ( {Av}_{m} , {Bv}_{m} , {φ}_{j}^{′} )$$

$$log ( {Kh}_{j} ( {A}_{i} , {B}_{i} , {φ}_{j}^{′} ) ) = ( {A}_{i} \cdot f ( φ {,}_{j} ) + {B}_{i} )$$

$$\overline{K} h ( {A}_{i} , {B}_{i} ) = {\sum }_{j = 1}^{n} {F}_{j} \cdot {Kh}_{j} ( {A}_{i} , {B}_{i} , {φ}_{j}^{′} )$$

and where 0<Cᵥ<0.25 (the high bound of this coefficient being determined for example by the user as a function of the nature of the reservoir) and during the step H500, calculating at least one total vertical mean permeability from the equations:

$$\overline{1 / {Kvt}_{S}} ( {A}_{i} , {B}_{i} , {Av}_{m} , {Bv}_{m} ) = {\sum }_{j = 1}^{n} ( 1 / {Kvt}_{j} ( {A}_{i} , {B}_{i} , {Av}_{m} , {Bv}_{m} , {φ}_{j}^{′} ) ) \cdot {LNA}_{S} ( {φ}_{j}^{′} , m , {S}_{1} , \frac{{S}_{1}}{{S}_{2}} )$$

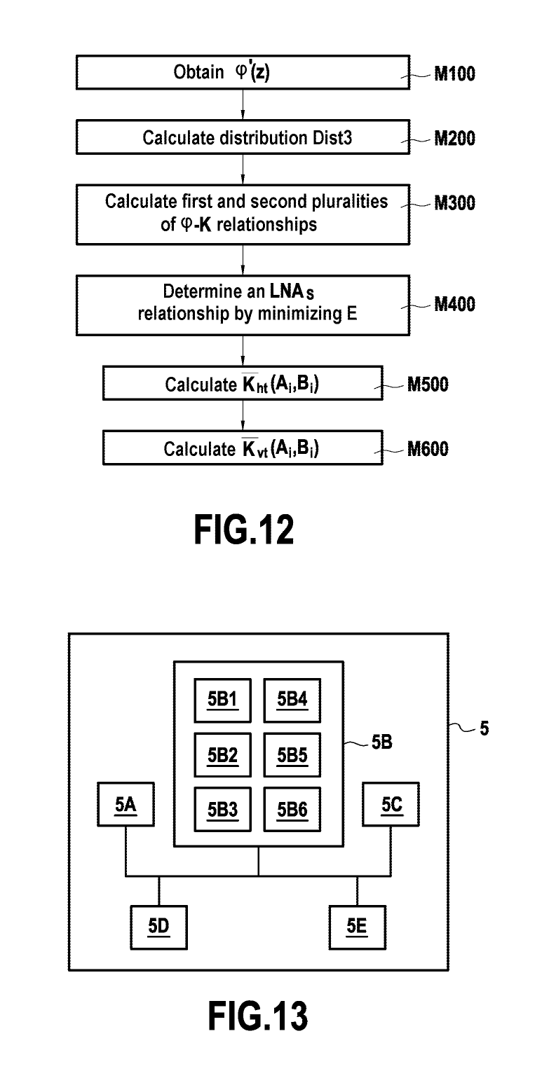

With reference to FIG. 12, there follows a description of the main steps of a method of estimating a total horizontal mean permeability and a total vertical mean permeability for a well 2 of the reservoir 1 in a first implementation in which the method is performed by an estimator device 4.

During a step M100, the estimator device 4 acquires a measurement of the porosity φ′(z) along the portion S of the well 2.

During a step M200, the porosity data φ′(z) obtained in step M100 is made discrete occupying n values and the experimental distribution Dist3 of the discrete data ϕᵢ′ is calculated. This experimental distribution Dist3 is characterized by the frequencies Fᵢ at which each of the values for ϕᵢ′ occurs. It should be observed that by definition the following relationship is true:

$${\sum }_{i = 1}^{n} {F}_{i} = 1$$

In the presently-described example, the estimator device 4 acts during the step M300 to calculate a first set of φ-K relationships associating porosity with horizontal permeability for the section S of the well 2 by applying a method in accordance with the invention for determining such a set of relationships. The first set of φ-K relationships as obtained in this way is expressed in the form log(Kh)=(Aᵢ·f(ϕ′)+Bᵢ), where Kh is a horizontal permeability, Aᵢ and Bᵢ are two real parameters belonging to a determined region of cardinal number N of the space defined by the parameters A, B, and f is the function f(φ′)=φ′ or the function f(φ′)=log(φ′).

During step M300, while performing the determination method, the estimator device 4 also determines a second set of φ-K relationships associating porosity with vertical permeability for the section S of the well 2. This second set of φ-K relationships is expressed in the form log(Kv)=((Aᵢ+dA)·f(ϕ′)+Bᵢ+dB), where Kv is a vertical permeability and dA and dB are two real parameters.

Thereafter, during a step M400, the estimator device determines the parameters of the asymmetric normal relationship LNA_{S}(φ′; m_{S}, S_{1,s}, S_{1,s}/S_{2,s}) that minimizes a target function E=αE₁+(1−α)[(1−β)E₃+βE₂], where α and β are two positive coefficients that are less than one, and where:
the term

$${E}_{1} = {\sum }_{i = 1}^{n} {( {F}_{i} - LNA ( {φ}_{i}^{′} , m , {S}_{1} , {S}_{1} / {S}_{2} ) )}^{2}$$

favors asymmetric normal relationships that best approximate the experimental porosity distribution;
the term

E₂=(ϕ̅ᵢ̅′̅−L̅N̅A̅(m,S₁,S₁/S₂))²

favors asymmetric normal relationships LNA(m, S₁, S₁/S₂) of mean value L̅N̅A̅(m, S₁, S₁/S₂) that best corresponds to the mean value φ̅ᵢ̅′̅ of the porosity measurements; and
the term

$${E}_{3} = {\sum }_{i = 1}^{N} {( \overline{Kh} t ( {A}_{i} , {B}_{i} ) - \overline{Kht} ( {A}_{i} , {B}_{i} , m , {S}_{1} , {S}_{1} / {S}_{2} ) )}^{2} + {( \overline{Kv} t ( {A}_{i} , {B}_{i} ) - \overline{Kvt} ( {A}_{i} , {B}_{i} , m , {S}_{1} , {S}_{1} / {S}_{2} ) )}^{2}$$

favors asymmetric normal relationships for which:
the values of the total horizontal mean permeability (defined by the equations:

$$\overline{Kht} ( {A}_{i} , {B}_{i} ) = {C}_{h} \cdot \overline{Kh} ( {A}_{i} , {B}_{i} ) + ( 1 - {C}_{h} ) \cdot \overline{Kv} ( {A}_{i} , {B}_{i} )$$

$$1 / \overline{Kv} ( {A}_{i} , {B}_{i} ) = {\sum }_{j = 1}^{n} {F}_{j} / {Kv}_{j} ( {A}_{i} , {B}_{i} )$$

$$\overline{K} h ( {A}_{i} , {B}_{i} ) = {\sum }_{j = 1}^{n} {F}_{j} \cdot {Kh}_{j} ( {A}_{i} , {B}_{i} )$$

and 0.75<Cₕ<1) as calculated after applying the relationships:

log(Khⱼ(Aᵢ,Bᵢ))=(Aᵢ·f(ϕ′ⱼ)+Bᵢ)

and

log(Kvⱼ(Aᵢ,Bᵢ))=((Aᵢ+dA)·f(ϕ′ⱼ)+Bᵢ+dB)

to the experimental porosity data φᵢ′ are close to the values of the total horizontal mean permeability K̅h̅t̅(Aᵢ, Bᵢ, m, S₁, S₁/S₂) calculated after applying the φ-K relationship to the asymmetric normal relationship LNA(φ; m, S₁, S₁/S₂) approximating the experimental porosity data; and
the total vertical mean permeability values (defined by the equations:

$$\overline{Kvt} ( {A}_{i} , {B}_{i} ) = {C}_{v} \cdot \overline{Kh} ( {A}_{i} , {B}_{i} ) + ( 1 - {C}_{v} ) \cdot \overline{Kv} ( {A}_{i} , {B}_{i} )$$

$$1 / \overline{Kv} ( {A}_{i} , {B}_{i} ) = {\sum }_{j = 1}^{n} {F}_{j} / {Kv}_{j} ( {A}_{i} , {B}_{i} ) , \\ \overline{K} h ( {A}_{i} , {B}_{i} ) = {\sum }_{j = 1}^{n} {F}_{j} \cdot {Kh}_{j} ( {A}_{i} , {B}_{i} )$$

and
0<Cᵥ<0.25) calculated after applying the relationships:

log(Khⱼ(Aᵢ,Bᵢ))=(Aᵢ·f(ϕ′ⱼ)+Bᵢ)

and

log(Kvⱼ(Aᵢ,Bᵢ))=((Aᵢ+dA)·f(ϕ′ⱼ)+Bᵢ+dB)

to the experimental porosity data φᵢ′ are close to the values of the total vertical mean permeability K̅v̅t̅(Aᵢ, Bᵢ, m, S₁, S₁/S₂) calculated after applying the φ-K relationships to the asymmetric normal relationship LNA(φ; m, S₁, S₁/S₂) approximating the experimental porosity data.

The target function E is minimized, e.g. by using the conjugate gradient method with as the initial point (m, S₁, S₁/S₂)=(ϕ̅ᵢ̅′̅, σ² (ϕᵢ′), 1), where φ̅ᵢ̅ represents the mean value of the data φ̅ᵢ̅ and σ²(ϕᵢ′) represents the standard deviation.

During the step M500, at least one total horizontal mean permeability K̅h̅t̅_{S} is estimated for the portion S of the well 2 from the optimum asymmetric normal relationship as determined during step M400, and from the first and second sets of φ-K relationships associating porosity with horizontal permeability and with vertical permeability for the section S of the well.

In other words, the total horizontal mean permeability K̅h̅t̅_{S} is determined for at least one pair (Aᵢ, Bᵢ) from the equation:

$$\overline{{Kht}_{s}} ( {A}_{i} , {B}_{i} ) = {\sum }_{j = 1}^{n} {Kht}_{j} ( {A}_{i} , {B}_{i} ) \cdot {LNA}_{s} ( {φ}_{j}^{′} , m , {S}_{1} , {S}_{1} / {S}_{2} )$$

where LNA_{S} is the asymmetric normal relationship minimizing the target function E.

During the step M600, the estimator device determines the total vertical mean permeability K̅v̅t̅_{S} for at least one pair (Aᵢ, Bᵢ) from the equation:

$$\overline{1 / {Kvt}_{s}} ( {A}_{i} , {B}_{i} ) = {\sum }_{j = 1}^{n} ( 1 / {Kvt}_{j} ( {A}_{i} , {B}_{i} ) ) \cdot {LNA}_{s} ( {φ}_{j}^{′} , m , {S}_{1} , {S}_{1} / {S}_{2} )$$

With reference to FIG. 13, there follows a description of a calculation device 5 of the invention for calculating mean permeability at a location (x, y) in an underground reservoir 1 in a particular implementation. This calculation device 5 has the hardware architecture of a computer.

Thus, the calculation device 5 comprises in particular a processor 5A, a ROM 5B, a RAM 5C, a non-volatile memory 5D, and communication means 5E.

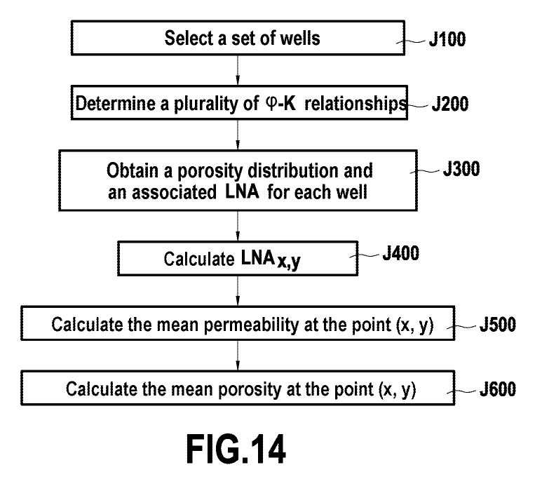

The ROM 5B of the calculation device constitutes a data medium that is readable by the processor aA and that stores a computer program in accordance with the invention comprising instructions for executing steps of a calculation method for calculating a mean permeability in accordance with the invention, the steps of the calculation method being described below with reference to FIG. 14, in a particular implementation.

In equivalent manner, the computer program defines functional modules of the calculation device, such as in particular a selection module 5B1 for selecting a set of wells of a reservoir, a determination device 5B2 for determining a plurality of first relationships, an obtaining module 5B3 for obtaining a porosity data distribution, an obtaining module 5B4 for obtaining a probability relationship, a calculation module 5B5 for calculating a probability relationship, and a calculation module 5B6 for calculating the mean permeability.

With reference to FIG. 14, there follows a description of the main steps of a calculation method for calculating mean permeability at a location (x, y) of an underground reservoir 1 in a first implementation in which the method is performed by a calculation device 5 of FIG. 13.

In a step J100, the calculation device 5 selects a set of wells of the reservoir 1. In the presently-described example, the set of wells contains a plurality of wells 2.

In a step J200, the calculation device 5 determines a plurality of first φ-K relationships associating permeability with porosity for the set of selected wells. In order to perform this determination, the calculation device 5 makes use of the determination device 5B2.

For each of the wells of the set of wells selected in step J100, the calculation device 5 obtains a porosity data distribution for the well and an asymmetric normal relationship approximating this porosity data distribution on the basis of the plurality of first φ-K relationships (step J300). By way of example, the asymmetric normal relationship is obtained in compliance with above-described steps H200, H300, and H400. It is also assumed that the uniform scalar quantifier used during step H200 is the same for each of the wells of the set of selected wells.

During step J400, the calculation device 5 calculates an asymmetric normal relationship LNA_{x,y} at the location (x, y) from the asymmetric normal relationships obtained for each of the wells during the step J300.

More precisely, the parameters m, S₁, and S₂ of the asymmetric normal relationship at the location (x, y) are obtained by interpolation (e.g. linear interpolation) of the parameters m, S₁, and S₂ of the asymmetric normal relationships obtained for each of the wells during the step J400.

It should be observed that this asymmetric normal relationship LNA_{x,y} represents the porosity distribution at the location (x, y).

Thereafter, during the step J500, the calculation device 5 calculates a mean permeability at the location (x, y) by using the asymmetric normal relationship at the point (x, y), and one of the φ-K relationships from the plurality of first φ-K relationships.

For example, when the permeability is a horizontal permeability, the mean of the horizontal permeability K̅h̅ is given by the formula:

$$\overline{Kh} ( {A}_{i} , {B}_{i} ) = {\sum }_{j = 1}^{n} exp ( {A}_{i} \cdot f ( {φ}_{j} ) + {B}_{i} ) \cdot {LNA}_{x , y} ( {φ}_{j}^{′} , {m}_{x , y} , {S}_{1 , x , y} , {S}_{1 , x , y} / {S}_{2 , x , y} )$$

where Aᵢ and Bᵢ are coefficients that define the relationship selected from the plurality of φ-K relationships.

In a variant, when the permeability is a vertical permeability, the mean K̅v̅ of this vertical permeability is given by the formula:

1/

$$\overline{Kv} ( {A}_{i} , {B}_{i} ) = ( 1 / ( {\sum }_{j = 1}^{n} 1 / exp ( {A}_{i} \cdot f ( {φ}_{j} ) + {B}_{i} ) ) \cdot {LNA}_{x , y} ( {φ}_{j}^{′} , {m}_{x , y} , {S}_{1 , x , y} , {S}_{1 , x , y} / {S}_{2 , x , y} ) )$$

where Aᵢ and Bᵢ are coefficients that define the relationship selected from the plurality of φ-K relationships, ϕⱼ′ representing the quantified values associated with a porosity value interval.

It should be observed that the asymmetric normal relationship LNA_{x,y} also serves in step J600 to calculate the mean porosity at the point (x, y) of the reservoir. This mean porosity at the point (x, y) is given by the formula:

$${\sum }_{j = 1}^{n} {LNA}_{x , y} ( {φ}_{j}^{′} , {m}_{x , y} , {S}_{1 , x , y} , {S}_{1 , x , y} / {S}_{2 , x , y} )$$

1. A method for associating permeability with porosity within an underground reservoir, the method comprising:
an obtaining step that comprises obtaining a first plurality of measurement points for the reservoir, each measurement point comprising a porosity data value and a first permeability data value;
a definition step that comprises defining a family of relationships associating porosity with at least one permeability;
a first counting step that comprises, for each relationship of the family, counting measurement points in the first plurality of measurement points reproduced by the relationship; and
a selection step that comprises selecting a plurality of first relationships in the family based on at least a result of the counting step.

2. The method according to claim 1, wherein the selected plurality of first relationships is selected from the relationships of the family that reproduce at least some minimum number of measurement points of the first plurality of measurement points.

3. The method according to claim 1, wherein, for each relationship of the family, the result of the counting step is weighted so as to be greater if the measurement points reproduced by the relationship are distributed along a vicinity of a curve representing the relationship.

4. The method according to claim 1, wherein the relationships associating porosity with at least one permeability are determined by at least two parameters.

5. The method according to claim 1, wherein the relationships of the family of relationships are log-log relationships defined by two parameters A and B, and the counting step comprises:
a transformation step that comprises transforming the plurality of measurement points by applying a logarithm function to the first permeability data values and to the porosity data values; and
a representation step that comprises representing the plurality of transformed points in a form of an intensity image;
the first counting step comprising counting a number of points in the plurality of transformed points represented in the intensity image that are at a distance that is below a threshold from a straight line having an equation of Y=A·X+B.

6. The method according to claim 1, wherein the relationships of the family of relationships are semi-log relationships defined by two parameters A and B, and the counting step comprises:
a transformation step that comprises transforming the plurality of measurement points by applying a logarithm function to the first permeability data values; and
a representation step that comprises representing a longitudinal of the plurality of transformed points in a form of an intensity image;
the first counting step comprising counting a number of points in the plurality of transformed points represented in the intensity image that are at a distance that is below a threshold from a straight line having an equation of Y=A·X+B.

7. The method according to claim 1, wherein the counting step comprises forming an intensity image; and
further comprising a smoothing step that comprises smoothing the intensity image prior to counting the measurement points.

8. The method according to claim 1, wherein the porosity data values and the first permeability data values are obtained by analyzing sample cores from the reservoir or by analyzing logging measurements, and
wherein the obtaining step further comprises an addition step that comprises adding additional measurement points to the first plurality of measurement points, the added additional measurement points being selected based on analyzing second permeability data values obtained from at least one formation test performed within the reservoir.

9. The method according to claim 8, wherein the addition step further comprises:
a second obtaining step that comprises obtaining a real histogram of logarithms of the first permeability data values obtained by analyzing the sample cores or by analyzing the logging measurements;
a third obtaining step that comprises obtaining a theoretical histogram of logarithms of the second permeability data values obtained from the at least one formation test, intervals of the theoretical histogram being equal to intervals of the real histogram;
a fourth obtaining step that comprises obtaining an aggregated probability histogram by calculating a product between the theoretical and real histograms; and
a fifth obtaining step that comprises, for at least one permeability interval in which the aggregated histogram is not zero, obtaining a set of additional measurement points, a number of additional measurement points of the set being a function of a value of the aggregated histogram evaluated for the at least one permeability interval, the additional measurement points being selected randomly from among the measurement points for which the first permeability data value corresponds to the at least one permeability interval.

10. The method according to claim 8, wherein the first and second permeability data values are horizontal permeabilities.

11. The method according to claim 8, wherein the first and second permeability data values are vertical permeabilities.

12. The method according to claim 10, wherein the family of relationships is determined by a plurality of parameters, and the method further comprises:
a second obtaining step that comprises obtaining a second plurality of measurement points, each of the second plurality of measurement points comprising one of the porosity data values and a third data value for vertical permeability;
a second counting step that comprises, for each relationship of the family, counting points of the second plurality of measurement points that are reproduced by the relationship;
a representation step that comprises representing results of the first and second counting steps in a form of first and second intensity signals depending on the plurality of parameters;
an estimation step that comprises estimating a translation vector by analyzing a correlation between the first and second intensity signals; and
a shift step that comprises shifting the second intensity signal by the translation vector;
the selection step taking account at least of the analysis of the correlation between the first intensity signal and the second intensity signal, the method further comprising determining a plurality of second relationships associating vertical permeability with porosity, the plurality of second relationships being obtained from the plurality of first relationships by shifting the parameters by the vector.

13. The method according to claim 11, wherein the family of relationships is determined by a plurality of parameters, and the method further comprises:
a second obtaining step that comprises obtaining a second plurality of measurement points, each of the second plurality of measurement points comprising one of the porosity data values and a third data value for horizontal permeability;
a second counting step that comprises, for each relationship of the family, counting points of the second plurality of measurement points that are reproduced by the relationship;
a representation step that comprises representing results of the first and second counting steps in a form of first and second intensity signals depending on the plurality of parameters;
an estimation step that comprises estimating a translation vector by analyzing a correlation between the first and second intensity signals; and
a shift step that comprises shifting the second intensity signal by the translation vector;
the selection step taking account at least of the analysis of the correlation between the first intensity signal and the second intensity signal, the method further comprising determining a plurality of second relationships associating horizontal permeability with porosity, the plurality of second relationships being obtained from the plurality of first relationships by shifting the parameters by the vector.

14. The method according to claim 12, further comprising a normalization step that comprises normalizing the first and second intensity signals prior to the estimation step.

15. The method according to claim 1, further comprising:
a second obtaining step that comprises obtaining a porosity data distribution for a set of wells;
a third obtaining step that comprises obtaining the plurality of first relationships associating porosity with permeability for the set of wells;
a fourth obtaining step that comprises obtaining a probability relationship approximating the distribution based on at least the plurality of first relationships; and
an estimation step that comprises estimating at least one mean permeability for the set of wells from at least the probability relationship and the plurality of first relationships.

16. The method according to claim 15, wherein the fourth obtaining step comprises minimizing a target function taking account of at least one term from among:
a first term favoring probability relationships best approximating the porosity data distribution;
a second term favoring probability relationships of mean value best approximating a mean value of the porosity data distribution; and
a third term favoring probability relationships that, for each relationship selected from the plurality of first relationships, minimize a sum of differences between a mean probability value calculated after applying the selected relationship to the porosity data distribution and a mean permeability value calculated after applying the selected relationship to the probability relationship.

17. The method according to claim 16, wherein:
the plurality of first relationships is defined by a relationship log(Kh)=(Aᵢ·f(ϕ)+Bᵢ), where Kh is a horizontal permeability, Aᵢ and Bᵢ are two real parameters belonging to a determined region of space defined by parameters A and B, and f is an identity function or a log function; and
the target function is a linear combination αEᵢ+(1−α)[(1−β)E₃+βE₂], where α and β are two positive coefficients and less than one, and where:
E1 is equal to
$${\sum }_{i = 1}^{n} {( {F}_{i} - LP ( {φ}_{i} , {S}_{1} , … , {S}_{g} ) )}^{2} ;$$
E2 is equal to (ϕ̅ᵢ̅ −L̅P̅(S₁, . . . , S_{g}))²; and
E3 is equal to
$${\sum }_{i = 1}^{n} {( \overline{K} h ( {A}_{i} , {B}_{i} ) - \overline{K} h ( {A}_{i} , {B}_{i} , m , {S}_{1} , … , {S}_{g} ) )}^{2}$$
with log (Khⱼ(Aᵢ,Bᵢ,ϕⱼ))=(Aᵢ·f(ϕⱼ)+Bᵢ) and
$$\overline{K} h ( {A}_{i} , {B}_{i} ) = {\sum }_{j = 1}^{n} {Kh}_{j} ( {A}_{i} , {B}_{i} , {φ}_{j} ) \cdot {F}_{j}$$
and where:
N is a cardinal number of the determined region of the space defined by the parameters A and B;
n is a number of intervals of the porosity data distribution;
Fᵢ is an occurrence frequency associated with each of the intervals of porosity ϕᵢ;
ϕ̅ᵢ̅ is a value associated with the porosity intervals; and
K̅h̅(Aᵢ, Bᵢ, S₁, . . . , S_{g}) is a mean horizontal permeability calculated after applying a relationship log(Kh)=(Aᵢ·f(ϕ)+Bᵢ) to a probability relationship LP(φ; S₁, . . . , S_{g}) depending on parameters S₁, . . . , S_{g}; and
the at least one mean permeability is a horizontal mean permeability K̅h̅_̅{̅S̅}̅ given by:
$$\overline{{Kh}_{S}} ( {A}_{i} , {B}_{i} ) = {\sum }_{j = 1}^{n} exp ( {A}_{i} , f ( {φ}_{j} ) + {B}_{i} ) \cdot {LP}_{S} ( {φ}_{j} ; {S}_{1} , … , {S}_{g} ) ,$$
where LP_{S} is a probability relationship minimizing the target function.

18. The method according to claim 16, wherein:
the plurality of first relationships is defined by a relationship log(Kv)=(Avᵢ·f(ϕ)+Bᵢ), where Kv is a horizontal permeability, Avᵢ and Bvᵢ are two real parameters belonging to a determined region of space defined by parameters Av and Bv, and f is an identity function or a log function; and
the target function is a linear combination αEᵢ+(1−α)[(1−β)E₃+βE₂], where α and β are two positive coefficients and less than one, and where:
E1 is equal to
$${\sum }_{i = 1}^{n} {( {F}_{i} - LP ( {φ}_{i} , {S}_{1} , … , {S}_{g} ) )}^{2} ;$$
E2 is equal to (ϕ̅ᵢ̅ −L̅P̅(S₁, . . . , S_{g}))²; and
E3 is equal to
$${\sum }_{i = 1}^{N} {( \overline{K} v ( {Av}_{i} , {Bv}_{i} ) - \overline{K} v ( {Av}_{i} , {Bv}_{i} , {S}_{1} , … , {S}_{g} ) )}^{2}$$
with log (Kvⱼ(Avᵢ,Bvᵢ,ϕⱼ))=(Aᵢ·f(ϕⱼ)+Bᵢ) and
$$1 / \overline{Kv} ( {Av}_{i} , {Bv}_{i} ) = {\sum }_{j = 1}^{n} {F}_{j} / {Kv}_{j} ( {Av}_{i} , {Bv}_{i} , {φ}_{j} )$$
and where:
N is a cardinal number of the determined region of the space defined by the parameters Av and Bv;
n is a number of intervals of the porosity data distribution;
Fᵢ is an occurrence frequency associated with each of the intervals of porosity ϕᵢ;
ϕ̅ᵢ̅ is a value associated with the porosity intervals; and
K̅v̅(Avᵢ, Bvᵢ, S₁, . . . , S_{g}) is a mean horizontal permeability calculated after applying a relationship log(Kv)=(Avᵢ·f(ϕ)+Bvᵢ) to a probability relationship LP(φ; S₁, . . . , S_{g}) depending on parameters S₁, . . . , S_{g}; and
the at least one mean permeability is a horizontal mean permeability K̅v̅_̅{̅S̅}̅ given by:
$$1 / \overline{Kv} ( {Av}_{i} , {Bv}_{i} ) = {\sum }_{j = 1}^{n} {LP}_{S} ( {φ}_{j} ; {S}_{1} , … , {S}_{g} ) / exp ( {Av}_{i} \cdot f ( {φ}_{j} ) + {Bv}_{i} ) ,$$
where LP_{S} is a probability relationship minimizing the target function.

19. The method according to claim 15, further comprising a fifth obtaining step that comprises obtaining a plurality of third relationships associating porosity to vertical permeability, and in which:
the plurality of first relationships associates porosity with horizontal permeability; and
a normal probability relationship is obtained by minimizing a target function taking account of at least one term from among:
a first term favoring probability relationships best approximating the porosity data distribution;
a second term favoring probability relationships of mean value best approximating a mean value of the porosity data distribution; and
a third term favoring probability relationships that, for each relationship selected from the plurality of first relationships and for each relationship selected from the third plurality of relationships, minimizes a sum of differences between a value of a total horizontal mean permeability calculated after application of the selected relationship to the porosity data distribution and the value of the total horizontal mean permeability calculated after applying the selected relationship to the probability relationship; and
the at least one mean permeability is the total horizontal mean permeability.

20. The method according to claim 19, wherein:
the plurality of first relationships is defined by a relationship log(Kh)=(Aᵢ·f(ϕ)+Bᵢ), where Kh is a horizontal permeability, Aᵢ and Bᵢ are two real parameters belonging to a determined region of space defined by parameters A and B, and f is an identity function or a log function;
the plurality of third relationships is defined by a relationship log(Kv)=(Avₘ·f(ϕ)+Bvₘ), where Kv is a vertical permeability and Avₘ and Bvₘ are two real parameters belonging to a determined region of space defined by parameters Av and Bv; and
the target function is a linear combination αE₁+(1−α)[(1−β)E₃+βE₂], where α and β are two positive coefficients and less than one, and where:
E1 is equal to
$${\sum }_{i = 1}^{n} {( {F}_{i} - LP ( {φ}_{i} , {S}_{1} , … , {S}_{g} ) )}^{2} ;$$
E2 is equal to (ϕ̅ᵢ̅ −L̅P̅(S₁, . . . , S_{g}))²; and
E3 is equal to
$${\sum }_{m = 1}^{M} {\sum }_{i = 1}^{N} {( \overline{K} ht ( {A}_{i} , {B}_{i} , {Av}_{m} , {Bv}_{m} ) - \overline{Kht} ( {A}_{i} , {B}_{i} , {Av}_{m} , {Bv}_{m} , {S}_{1} , … , {S}_{g} ) )}^{2}$$
$$with$$
$$\overline{Kht} ( {A}_{i} , {B}_{i} , {Av}_{m} , {Bv}_{m} ) = {C}_{h} \cdot \overline{Kh} ( {A}_{i} , {B}_{i} ) + ( 1 - {C}_{h} ) \cdot \overline{Kv} ( {Av}_{m} , {Bv}_{m} ) ;$$
$$log ( {Kv}_{j} ( {Av}_{m} , {Bv}_{m} , {φ}_{j} ) ) = ( {Av}_{m} \cdot f ( {φ}_{j} ) + {Bv}_{m} ) ;$$
$$1 / \overline{Kv} ( {Av}_{m} , {Bv}_{m} ) = {\sum }_{j = 1}^{n} {F}_{j} / {Kv}_{j} ( {Av}_{m} , {Bv}_{m} , {φ}_{j} ) ;$$
$$log ( {Kh}_{j} ( {A}_{i} , {B}_{i} , {φ}_{j} ) ) = ( {A}_{i} \cdot f ( {φ}_{j} ) + {B}_{i} ) ;$$
$$\overline{K} h ( {A}_{i} , {B}_{i} ) = {\sum }_{j = 1}^{n} {F}_{j} \cdot {Kh}_{j} ( {A}_{i} , {B}_{i} , {φ}_{j} )$$
and where:
Cₕ is a positive coefficient lying in a range 0 to 1;
N is a cardinal number of the determined region of the space defined by the parameters A and B;
M is a cardinal number of the determined region of the space defined by the parameters Av and Bv;
n is a number of intervals of the porosity data distribution;
Fᵢ is an occurrence frequency associated with each of the intervals of porosity ϕᵢ;
ϕ̅ᵢ̅ is a value associated with the porosity intervals; and
K̅h̅t̅(Aᵢ, Bᵢ, Avₘ, Bvₘ, S₁, . . . , S_{g}) is a mean vertical permeability calculated after applying relationships log(Kh)=(Aᵢ·f(ϕ)+Bᵢ) and log(Kv)=(Avₘ·f(ϕ)+Bvᵢₘ) to a probability relationship LP(φ; S₁, . . . , S_{g}) depending on a parameters S₁, . . . , S_{g}; and
the at least one mean permeability is a total vertical mean permeability given by:
$$\overline{{Kht}_{S}} ( {A}_{i} , {B}_{i} , {Av}_{m} , {Bv}_{m} ) = {\sum }_{j = 1}^{n} {Kht}_{j} ( {A}_{i} , {B}_{i} , {Av}_{m} , {Bv}_{m} , {φ}_{j} ) \cdot {LP}_{S} ( {φ}_{j} ; {S}_{1} , … , {S}_{g} ) ;$$
where LP_{S} is a probability relationship minimizing the target function.

21. The method according to claim 15, further comprising a fifth obtaining step that comprises obtaining a plurality of third relationships associating porosity with vertical permeability, and wherein:
the plurality of first relationships associates porosity with horizontal permeability; and
a normal probability relationship is obtained by minimizing a target function taking account of at least one term from among:
a first term favoring probability relationships best approximating the porosity data distribution;
a second term favoring probability relationships of mean value best approximating a mean value of the porosity data distribution; and
a third term favoring probability relationships that, for each relationship selected from the plurality of first relationships and for each relationship selected from the plurality of third relationships, minimizes a sum of differences between a value of a total vertical mean permeability calculated after applying the selected relationship to the porosity data distribution and the total vertical mean permeability calculated after applying the relationship selected to the probability relationship; and
the at least one mean permeability is the total vertical mean permeability.

22. The method according to claim 21, wherein:
the plurality of first relationships is defined by a relationship log(Kh)=(Aᵢ·f(ϕ)+Bᵢ), where Kₕ is a horizontal permeability, Ai and Bi are two real parameters belonging to a determined region of space defined by parameters A and B, and f is an identity function or a log function; and
the plurality of third relationships is defined by a relationship log(Kv)=(Avₘ·f(ϕ)+Bvₘ), where Kᵥ is a vertical permeability and Avₘ and Bvₘ are two real parameters belonging to a determined region of space defined by parameters Av and Bv; and
the target function is a linear combination αE₁+(1−α)[(1−β)E₃+βE₂], where α and β are two positive coefficients and less than one, and where:
E1 is equal to
$${\sum }_{j = 1}^{n} {( {F}_{i} - LP ( {φ}_{i} , {S}_{1} , … , {S}_{g} ) )}^{2} ;$$
E2 is equal to (ϕ̅ᵢ̅ −L̅P̅(S₁, . . . , S_{g}))²; and
E3 is equal to
$${\sum }_{m = 1}^{M} {\sum }_{i = 1}^{N} {( \overline{K} vt ( {A}_{i} , {B}_{i} , {Av}_{m} , {Bv}_{m} ) - \overline{Kvt} ( {A}_{i} , {B}_{i} , {Av}_{m} , {Bv}_{m} , {S}_{1} , … , {S}_{g} ) )}^{2}$$
$$with$$
$$\overline{Kvt} ( {A}_{i} , {B}_{i} , {Av}_{m} , {Bv}_{m} ) = {C}_{v} \cdot \overline{Kh} ( {A}_{i} , {B}_{i} ) + ( 1 - {C}_{v} ) \cdot \overline{Kv} ( {Av}_{m} , {Bv}_{m} ) ;$$
$$log ( {Kv}_{j} ( {Av}_{m} , {Bv}_{m} , {φ}_{j} ) ) = ( {Av}_{m} \cdot f ( {φ}_{j} ) + {Bv}_{m} ) ;$$
$$1 / \overline{Kv} ( {Av}_{m} , {Bv}_{m} ) = {\sum }_{j = 1}^{n} {F}_{j} / {Kv}_{j} ( {Av}_{m} , {Bv}_{m} , {φ}_{j} ) ;$$
$$log ( {Kh}_{j} ( {A}_{i} , {B}_{i} , {φ}_{j} ) ) = ( {A}_{i} \cdot f ( {φ}_{j} ) + {B}_{i} ) ;$$
$$\overline{K} h ( {A}_{i} , {B}_{i} ) = {\sum }_{j = 1}^{n} {F}_{j} \cdot {Kh}_{j} ( {A}_{i} , {B}_{i} , {φ}_{j} )$$
and where:
Cᵥ is a positive coefficient lying in a range 0 to 1;
N is a cardinal number of the determined region of the space defined by the parameters A and B;
M is a cardinal number of the determined region of the space defined by the parameters Av and Bv;
n is a number of intervals of the porosity data distribution;
Fᵢ is an occurrence frequency associated with each of the intervals of porosity ϕᵢ;
ϕ̅ᵢ̅ is a value associated with the porosity intervals; and
K̅v̅t̅(Aᵢ, Bᵢ, Avₘ, Bvₘ, S₁, . . . , S_{g}) is a mean vertical permeability calculated after applying relationships log(Kh)=(Aᵢ·f(ϕ)+Bᵢ) and log(Kv)=(Avₘ·f(ϕ)+Bvᵢₘ) to a probability relationship LP(φ; S₁, . . . , S_{g}) depending on a parameters S₁, . . . , S_{g}; and
the at least one mean permeability is a total vertical mean permeability given by:
$$\overline{1 / {Kvt}_{S}} ( {A}_{i} , {B}_{i} , {Av}_{m} , {Bv}_{m} ) = {\sum }_{j = 1}^{n} 1 / {Kvt}_{j} ( {A}_{i} , {B}_{i} , {Av}_{m} , {Bv}_{m} , {φ}_{j} ) \cdot {LP}_{S} ( {φ}_{j} ; {S}_{1} , … , {S}_{g} ) ;$$
where LP_{S} is a probability relationship minimizing the target function.

23. The method according to claim 15, wherein the fourth obtaining step is performed based on a plurality of second relationships associating vertical permeability with porosity, the method further comprising an estimation step that comprises estimating at least one total vertical mean permeability based on at least the probability relationship and the plurality of second relationships.

24. The method according to claim 15, wherein the fourth obtaining step is performed by minimizing a target function taking account of at least one term from among:
a first term favoring probability relationships best approximating the porosity data distribution;
a second term favoring probability relationships of mean value best approximating a mean value of the porosity data distribution; and
a third term favoring probability relationships that, for each selected relationship, minimize the plurality of first relationships such that:
a sum of differences between a value of a total horizontal mean permeability calculated after applying the selected relationship to the porosity data distribution and the value of the total horizontal mean permeability calculated after applying the selected relationship to the probability relationship; and
a sum of differences between a value of a total vertical mean permeability calculated after applying the selected relationship to the porosity data distribution and the value of the total vertical mean permeability calculated after applying the selected relationship to the probability relationship.

25. The method according to claim 24, wherein:
the plurality of first relationships is defined by a relationship log(K_{H})=(Aᵢ·f(ϕ)+Bᵢ), where Kh is a horizontal permeability, Aᵢ and Bᵢ are two real parameters belonging to a determined region of space defined by parameters A and B, and f is an identity function or a log function; and
the plurality of second relationships is defined by a relationship log(K_{V})=((Aᵢ+dA)·f(ϕ)+Bᵢ+dB), where Kv is a vertical permeability and dA and dB are two real parameters; and
the target function is a linear combination αE₁+(1−α)[(1−β)E₃+βE₂], where α and β are two positive coefficients and less than one, and where:
E1 is equal to
$${\sum }_{j = 1}^{n} {( {F}_{i} - LP ( {φ}_{i} , {S}_{1} , … , {S}_{g} ) )}^{2} ;$$
E2 is equal to (ϕ̅ᵢ̅ −L̅P̅(S₁, . . . , S_{g}))²; and
E3 is equal to
$${\sum }_{i = 1}^{N} {( \overline{Kh} t ( {A}_{i} , {B}_{i} ) - \overline{Kht} ( {A}_{i} , {B}_{i} , m , {S}_{1} , … , {S}_{g} ) )}^{2} + {( \overline{Kv} t ( {A}_{i} , {B}_{i} ) - \overline{Kvt} ( {A}_{i} , {B}_{i} , m , {S}_{1} , … , {S}_{g} ) )}^{2}$$
$$with$$
$$\overline{Kht} ( {A}_{i} , {B}_{i} ) = {C}_{h} \cdot \overline{Kh} ( {A}_{i} , {B}_{i} ) + ( 1 - {C}_{h} ) \cdot \overline{Kv} ( {A}_{i} , {B}_{i} ) ;$$
$$\overline{Kvt} ( {A}_{i} , {B}_{i} ) = {C}_{v} \cdot \overline{Kh} ( {A}_{i} , {B}_{i} ) + ( 1 - {C}_{v} ) \cdot \overline{Kv} ( {A}_{i} , {B}_{i} ) ;$$
$$log ( {Kv}_{j} ( {A}_{i} , {B}_{i} ) ) = ( ( {A}_{i} + dA ) \cdot f ( {φ}_{j} ) + {B}_{i} + dB ) and$$
$$1 / \overline{Kv} ( {A}_{i} , {B}_{i} ) = {\sum }_{j = 1}^{n} {F}_{j} / {Kv}_{j} ( {A}_{i} , {B}_{i} ) ;$$
$$log ( {Kh}_{j} ( {A}_{i} , {B}_{i} ) ) = ( {A}_{i} \cdot f ( {φ}_{j} ) + {B}_{i} ) and$$
$$\overline{K} h ( {A}_{i} , {B}_{i} ) = {\sum }_{j = 1}^{n} {F}_{j} \cdot {Kh}_{j} ( {A}_{i} , {B}_{i} ) ,$$
and where:
Cₕ and Cᵥ is a positive coefficient lying in a range 0 to 1;
N is a cardinal number of the determined region of the space defined by the parameters A and B;
n is a number of intervals of the porosity data distribution;
Fᵢ is an occurrence frequency associated with each of the intervals of porosity ϕᵢ;
ϕ̅ᵢ̅ is a value associated with the porosity intervals; and
K̅h̅t̅(Aᵢ, Bᵢ, m, S₁, . . . , S₁/S₂) is a mean horizontal permeability calculated after applying relationships log(Kh)=(Aᵢ·f(ϕ)+Bᵢ) and log(Kv)=((Aᵢ+dA)·f(ϕ)+Bᵢ+dB) to a probability relationship LP(φ; S₁, . . . , S_{g}) depending on a parameters S₁, . . . , S_{g}; and
K̅v̅t̅(Aᵢ, Bᵢ, m, S₁, . . . , S₁/S₂) is the total vertical mean permeability calculated after applying a relationship log(Kv)=(Aᵢ+dA)·f(ϕ)+Bᵢ+dB) to the probability relationship LP(φ; S₁, . . . , S_{g}) depending on a parameters S₁, . . . , S_{g};
the at least one mean permeability is a total horizontal mean permeability given by:
$$\overline{{Kht}_{S}} ( {A}_{i} , {B}_{i} ) = {\sum }_{j = 1}^{n} {Kht}_{j} ( {A}_{i} , {B}_{i} ) \cdot {LP}_{S} ( {φ}_{j} , {S}_{1} , … , {S}_{g} )$$
where LP_{S} is a probability relationship minimizing the target function; and
at least one vertical mean permeability is given by:
$$\overline{1 / {Kht}_{S}} ( {A}_{i} , {B}_{i} ) = {\sum }_{j = 1}^{n} 1 / {Kht}_{j} ( {A}_{i} , {B}_{i} ) \cdot {LP}_{S} ( {φ}_{j} , {S}_{1} , … , {S}_{g} ) ) .$$

26. The method according to claim 15, wherein the probability relationship is a normal relationship or a linear combination of normal relationships.

27. The method according to claim 15, wherein the probability relationship is an asymmetric normal relationship.

28. The method according to claim 25, wherein the coefficient Cₕ is greater than 0.75 and less than 1.

29. The method according to claim 25, wherein the coefficient C_{V} is greater than 0 and less than 0.25.

30. The method according to claim 1, further comprising:
a second selection step that comprises selecting a set of wells of the reservoir, the set comprising at least one well;
a determination step that comprises determining the plurality of first relationships associating permeability with porosity for the set of wells, which includes for each well in the set:
a second obtaining step that comprises obtaining a porosity data distribution for the well; and
a third obtaining step that comprises obtaining a probability relationship approximating the distribution based on at least the plurality of first relationships;
a calculation step that comprises calculating a probability relationship at a location of the underground reservoir from the probability relationship obtained for each of the wells; and
a second calculation step that comprises calculating a mean permeability at the location from at least the probability relationship at the location and from at least the plurality of first relationships.

31. The method according to claim 30, further comprising a third calculation step that comprises calculating a mean porosity at the location from at least the probability relationship at the location.

32. (canceled)

33. A non-transitory computer-readable data medium having stored thereon a computer program comprising instructions that when executed cause at least one processor to:
obtain a plurality of measurement points for an underground reservoir, each measurement point comprising a porosity data value and a permeability data value;
define a family of relationships associating porosity with at least one permeability;
for each relationship of the family, count measurement points in the plurality of measurement points reproduced by the relationship; and
select a plurality of relationships in the family based on at least a result of the counting.

34.-37. (canceled)

38. A device for determining a plurality of first relationships associating permeability with porosity within an underground reservoir, the device comprising:
at least one processor; and
at least one memory storing computer-executable instructions that when executed cause the at least one processor to:
obtain a first plurality of measurement points for the reservoir, each measurement point comprising a porosity data value and a first permeability data value;
define a family of relationships associating porosity with at least one permeability;
for each relationship of the family, count measurement points of the first plurality of measurement points that are reproduced by the relationship; and
select a plurality of first relationships in the family based on at least a result of the counting.

39. The device according to claim 38, wherein the at least one memory further stores computer-executable instructions that when executed cause the at least one processor to:
obtain a porosity data distribution for a set of wells in the underground reservoir;
determine the plurality of first relationships associating porosity with permeability for the set of wells;
obtain a probability relationship approximating the distribution based on at least the plurality of first relationships; and
estimate at least one mean permeability for the set of wells from at least the probability relationship and the plurality of first relationships.

40. The device according to claim 38, wherein the at least one memory further stores computer-executable instructions that when executed cause the at least one processor to:
select a set of wells of the reservoir, the set comprising at least one well;
determining a determine the plurality of first relationships associating permeability with porosity for the set of wells;
obtain a porosity data distribution for each of the wells of the set;
obtain a probability relationship approximating the distribution for each of the wells of the set based on at least the plurality of first relationships;
calculate a probability relationship at a location of the underground reservoir from the probability relationship obtained for each of the wells; and
calculate a mean permeability at the location from at least the probability relationship at the location and from at least the plurality of first relationships.
